(19) United States
(12) Patent Application Publication
(10) Pub. No.: US 2013/0295272 A1
(43) Pub. Date: Nov. 7, 2013

(54) Granules of a Brittle Material for Room Temperature Granule Spray in Vacuum, and Method for Forming a Coating Film Using Same

(71) Applicants: Dong Soo Park, Changwon-si (KR); Jong-Woo Kim, Changwon-si (KR); Jung Ho Ryu, Changwon-si (KR); Woon-Ha Yoon, Changwon-si (KR); Jong Jin Choi, Busan (KR); Byung-Dong Hahn, Changwon-si (KR)

(72) Inventors: Dong Soo Park, Changwon-si (KR); Jong-Woo Kim, Changwon-si (KR); Jung Ho Ryu, Changwon-si (KR); Woon-Ha Yoon, Changwon-si (KR); Jong Jin Choi, Busan (KR); Byung-Dong Hahn, Changwon-si (KR)

(73) Assignee: KOREA INSTITUTE OF MACHINERY AND MATERIALS, Daejeon (KR)

(21) Appl. No.: 13/980,313

(22) PCT Filed: Jan. 4, 2012
(86) PCT No.: PCT/KR2012/000086

§ 371 Date: Jul. 17, 2013

(30) Foreign Application Priority Data
Jan. 18, 2011 (KR) 10-2011-0005094
Dec. 7, 2011 (KR) 10-2011-0130294

(51) Int. Cl. B05D 1/12

(52) U.S. Cl. CPC B05D 1/12
USPC 427/2.1; 427/180; 427/157; 428/338

(57) ABSTRACT

The present invention relates to granules of a brittle material for room-temperature granule spray in vacuum, and to a method for forming a coating film using same. Particularly, particles having a size of 0.1 to 6 μm are granulated and a coating film may be formed through room-temperature granule spray in vacuum using the granules. The granules of the brittle material according to exemplary embodiments may be used through the vacuum granule injection at room temperature and a coating process may be continuously performed. Since the granules injected through a nozzle have a relatively large mass and thus have a large amount of kinetic energy, the coating film may be formed at a low gas-flow rate, and the forming rate of the coating film may be increased. Therefore, the granules may be useful for forming a ceramic coating film.

### BACKGROUND

1. Field of the Invention

The present invention relates to granules of a brittle material whose properties are controlled for vacuum granule injection at room temperature and a method for forming a coating film using the same.

2. Description of the Related Art

Aerosol deposition is a process for preparing a dense coating film which generally involves feeding the fine particles of a brittle material without plastic deformation in size between several hundreds nm to several μm into a powder acceptor or aerosolizing mechanism, applying mechanical vibration and feeding carrier gas to make aerosol containing the gas and the fine particles, and injecting the aerosol through a nozzle at room temperature. The aerosol deposition, which prepares a coating film by colliding the fine particles against a substrate at a rate of 100-400 m/s to form a coating film, is different from the cold spray which prepares a coating film by colliding metal powder with plasticity against a substrate at a supersonic rate of 400-1500 m/s. For the aerosol deposition, kinetic energy based on mass and velocity of motion is the source of energy to make the fine powder with brittleness into a dense coating film. If the kinetic energy is too small, a coating film cannot be formed, or porous powder compacts can be formed. On the contrary, if the kinetic energy is too large, the substrate or coating film already formed can be eroded. Therefore, a proper amount of the kinetic energy is needed to form a coating film. There are several documents that describe the aerosol deposition. Japanese Patent No. 3348154 discloses a method for forming a coating film in a short space of time by injecting the fine particles of a brittle material. The patent document describes that the particles used for forming the coating film should have the mean diameter of 0.1-5 μm, and that the larger-sized agglomerates of the individual particles do not contribute to forming the coating film or rather can hinder the forming. However, the particles of raw powder can agglomerate in a powder acceptor or aerosolizing mechanism as time passes, thereby causing trouble for making a large-area uniform coating film fast which allows only limited commercial applications. To be specific, the particles in size of hundreds nm-several μm are attached physically by water adsorption or static attraction to agglomerate in the aerosol deposition. Due to the agglomeration of the particles of a brittle material, the particulate powder in the powder acceptor or aerosolizing mechanism of the apparatus for the aerosol deposition changes over time into agglomerates of uncontrollable, various sizes, thus obstructing the uniform and regular powder supply, and uniform and smooth injection through a nozzle. As a result, production and operation as well as the quality of the formed coating film are affected.

In the meantime, there are also the documents to solve the above-stated problems. Japanese Patent Publication No. 2009-242942 discloses a method of preparing the particles having the mean diameter of 20-500 μm and the compressive strength of 0.015-0.47 MPa by deliberately agglomerating the fine primary particles having the mean diameter of 0.1-5 μm for use as a raw material. Since these prepared particles have a sufficiently large size, the agglomeration among the prepared particles is controlled and accordingly, the powder can desirably be supplied for a long time. However, JP 2009-242942 is limited as in the case of JP Patent No. 3348154 in terms of the fact that forming a coating film requires storing the raw powder composed of the prepared particles in a powder acceptor, feeding the prepared particles from the powder acceptor uniformly into a separate milling apparatus to grind the prepared particles back into the fine particles with the mean diameter of 0.1-5 μm, and then injecting the fine particles through a nozzle. Korean Patent No. 10-2007-0008727 relates to a composite structured material, which is formed from a brittle material such as ceramic or metal on the surface of a substrate, and a method and apparatus for preparing the same. The above-mentioned Korean patent document describes the method for forming a coating film by injecting and colliding the particles of a brittle material such as ceramic or metal with prior internal deformation onto a substrate at high speed and breaking up the particles. However, the thickness of the coating film prepared by the method presented in the above-mentioned Korean patent may not be uniform.

Accordingly, the inventors of the present invention, who were researching on the methods of preventing the fine particles of a brittle material from agglomeration and thereby preventing the non-uniform supply of powder in the process of aerosol deposition, have completed the present invention after developing a method of controlling the properties of multi-particulate agglomerates or granules of a brittle material and a method of preparing a coating film of the brittle material using the same method, which enable the effective preparation of a fine-structured dense coating film without presence of pores, cracks, or lamella, by controlling the properties of brittle material powder to give flowability, inhibiting the particles from physical attachment and subsequent agglomeration, and injecting directly, i.e., without milling, the multi-particle agglomerates having a mean diameter of 5 μm or more and a proper strength. In the meantime, aerosol indicates a state where ultra-fine particles and gas are mixed. However, considering that the particles used for the present invention can hardly be referred to as “aerosol” because the particles mixed with gas are 5-500 μm sized granules, the coating process according to the present invention will be referred herein to as “room-temperature granule spray in vacuum”, instead of aerosol deposition that uses aerosol mixed with fine particles and carrier gas.

### SUMMARY OF THE INVENTION

The objective of the present invention is to provide granules of a brittle material for room-temperature granule spray in vacuum.

Further, another objective of the present invention is to provide a method for forming a coating film using the granules of the brittle material.

In order to achieve the aforementioned objectives, the present invention provides granules of a brittle material granulated from 0.1 to 6 μm powder particles, to form a coating film through room-temperature granule spray in vacuum.

Further, the present invention provides a method for forming a coating film using the granules of the brittle material, which includes the following steps of:

a material preparing step at which granules of a brittle material are charged into a feeder and a substrate is fixated on a stage (step 1);

a gas supplying step at which the granules of the brittle material and the carrier gas are mixed together (step 2); and

a granule injecting step at which the carrier gas and the granules of the brittle material mixed at step 2 are transported to a nozzle and injected onto the substrate of step 1 through the nozzle (step 3).

According to the present invention, the granules of a brittle material may be supplied through room-temperature granule spray in vacuum and coating may be performed subsequently. Since the granule mass is relatively large and accordingly kinetic energy is high, a coating film may be prepared even at a low gas flow and film forming speed may be increased. Therefore, the granules may be useful for preparing a ceramic coating film. Further, through a method for forming a coating film according to the present invention, a coating film having a porosity of 10% or less and a uniform and fine structure with no non-uniformities including cracks, large pores, or lamellar structure may be prepared.

### BRIEF DESCRIPTION OF THE DRAWINGS

FIG. 1 is a schematic drawing illustrating the granulation of a brittle material according to the present invention;

FIG. 2 is a schematic drawing illustrating a room-temperature granule spray in vacuum apparatus for preparing a coating film of a brittle material according to the present invention;

FIG. 3 is a graph obtained as a result of analyzing the particle size of Pb(Zr,Ti)O₃ raw powder;

FIG. 4 is a graph obtained as a result of analyzing the particle size of TiO₂ raw powder;

FIG. 5 is a graph obtained as a result of analyzing the particle sizes of raw powders used as a raw material for the granules of a brittle material according to the present invention;

FIG. 6 is a graph obtained as a result of comparing the particle sizes of brittle material granules and raw powders according to the present invention;

FIG. 7 and FIG. 8 are images obtained as a result of analyzing whether the granules of a brittle material (Al₂O₃) can form a coating film and the raw powder (Al₂O₃) whose average particle size is similar to that of the granules can form a coating film;

FIG. 9 includes a graph showing the changes in compressive strength of the Pb(Zr,Ti)O₃ granules according to heat treatment temperature, and images of the coating films formed by using the granules;

FIG. 10 includes a graph showing the changes in compressive strength of the TiO₂ granules according to heat treatment temperature, and images of the coating films formed by using the granules;

FIG. 11 includes a graph showing the changes in compressive strength of the yttria-stabilized zirconia (YSZ) granules according to heat treatment temperature, and images of the coating films formed by using the granules;

FIG. 12 is a table obtained as a result of analyzing whether coating is available according to compressive strength of the alumina granules according to the present invention;

FIG. 13 includes an image showing the coating film formed by using the molybdenum disulfide granules according to the present invention, and images of the coating films formed by using the molybdenum disulfide raw powder used for preparing the granules;

FIG. 14 is a graph obtained as a result of analyzing the Pb(Zr,Ti)O₃ granules prepared in Example 1 by means of X-ray diffraction analysis;

FIG. 15 is a graph obtained as a result of analyzing the aluminum nitride (AlN) granules prepared in Example 31 by means of X-ray diffraction analysis;

FIG. 16 is a graph obtained as a result of analyzing the coating film formed by room-temperature granule spray in vacuum of the Pb(Zr,Ti)O₃ granules prepared in Examples 2 and 8 by means of X-ray diffraction analysis;

FIG. 17 and FIG. 18 are images obtained as a result of observing the Pb(Zr,Ti)O₃ granules prepared in Example 1 through a scanning electron microscope;

FIG. 19 are images obtained as a result of observing the coating film formed by using the Pb(Zr,Ti)O₃ granules prepared in Example 8 through a scanning electron microscope;

FIG. 20 are images obtained as a result of observing the coating films formed by using the GDC granules prepared in Example 23 and the GDC/Gd₂O₃ granules prepared in Examples 25 and 27 through a scanning electron microscope;

FIG. 21 is an image obtained as a result of observing the hydroxyapatite granules prepared in Example 49 through a scanning electron microscope;

FIG. 22 are images obtained as a result of observing the hydroxyapatite granules prepared in Example 52 through a scanning electron microscope;

FIG. 23 are images obtained as a result of observing the coating film formed by using the hydroxyapatite granules prepared in Example 49 and the coating film formed by using the raw powder used for preparing the granules through a scanning electron microscope;

FIG. 24 and FIG. 25 are images obtained as a result of analyzing coating properties of the yttria-stabilized zirconia (YSZ) granules prepared in Example 21 according to coating condition;

FIG. 26 are images showing the large-area coating ability of the brittle material granules;

FIG. 27 are images obtained as a result of observing the particle states of the brittle material granules before and after coating through a scanning electron microscope;

FIG. 28 are graphs showing the electrical properties of the coating film formed by using the Pb(Zr,Ti)O₃ granules prepared in Example 7.

### DESCRIPTION OF THE PREFERRED EMBODIMENT

Hereinafter, the present invention will be described in detail.

The present invention provides the granules of a brittle material granulated from 0.1 to 6 μm powder particles, which form a high-density coating film through a room-temperature granule spray in vacuum.

According to the present invention, the granules of a brittle material have the mean diameter of 5-500 μm and the compressive strength of 0.05-20 MPa, the conditions that are desirable for the room-temperature granule spray in vacuum.

Aerosol deposition uses the powder of brittle material particles which are hundreds nm-several μm in size, and thus the powder may not be supplied continuously for coating in a uniform manner for a long time due to agglomeration by humidity or electrostatic interactions. The present invention resolves the above shortcoming by using the granules of a brittle material having a mean diameter of 5-500 μm, according to which attachment and agglomeration among the granules are controlled. Therefore, a long time continuous and uniform powder supply is enabled and a high-density coating film is formed on the surface of a substrate by injecting through a nozzle the granules with the strength (i.e., (compressive strength) of 0.05-20 MPa).

Meanwhile, if the strength of the granules is not sufficient, even the identically-sized granules can suffer shortcomings such as difficulty of handling the granules due to a weak binding force between the constituent particles, and absorption of most kinetic energy due to “cushioning effect” when colliding against the substrate and consumption for the slipperiness between the particles, which consequently hinders proper coating on the surface of the substrate, and causes porous compacts of the particles due to weakened binding force or a lamella structure of partially strong binding portions and compacts. On the contrary, when the granules have too high strength, the substrate or the coating film already formed may be eroded or the granules may be bounced off upon colliding. Therefore, a densely-structured coating film may not be formed. The granules of a brittle material according to the present invention have the strength (i.e., compressive strength) of 0.05-20 MPa to prevent the problems mentioned above, and thus may form a high-density coating film onto a substrate by being injected through a nozzle.

For aerosol deposition, the term “aerosol” means a mixed state of ultra-fine particles and carrier gas. However, the coating process of the present invention will be referred to herein as a “room-temperature granule spray in vacuum” rather than aerosol deposition, considering that the granules of a brittle material used for the present invention of 5-500 μm sized particles.

The granules of a brittle material according to the present invention form a coating film through the room-temperature granule spray in vacuum, without requiring an additional disintegrating process. In other words, the granules of a brittle material, not the aerosolized raw materials, are injected through a nozzle with the original form of the granules maintained.

The Japanese Patent Publication No. 2009-242942 discloses the aerosol deposition process using the particles as a raw material prepared by deliberate agglomeration. However, the prepared particles are supplied to a disintegrating apparatus to be disintegrated and aerosolized and then injected through a nozzle. Although the prepared particles are used as a raw material, it is the aerosolized material that is injected through the nozzle. Therefore, the process is limited only to the materials that can form a coating film through the aerosol deposition.

On the contrary, according to the present invention, even the materials such as MoS₂ that can not form a coating film through the conventional aerosol deposition process can be used to form a high-density coating film conveniently and quickly, by injecting the granules through a nozzle and without requiring additional disintegrating process.

The granules of a brittle material may use hydroxyapatite, calcium phosphate, bio glass, Pb(Zr,Ti)O₃(PZT), alumina, titanium dioxide, zirconia (ZrO₂), yttria (Y₂O₃), yttria stabilized zirconia (YSZ), dysprosia (Dy₂O₃), gadolinia (Gd₂O₃), ceria (CeO₂), gadolinia doped ceria (GDC), magnesia (MgO), barium titanate (BaTiO₃), nickel manganite (NiMn₂O₄), potassium sodium niobate (KNaNbO₃), bismuth potassium titanate (BiKTiO₃), bismuth sodium titanate (BiNaTiO₃), CoFe₂O₄, NiFe₂O₄, BaFe₂O₄, NiZnFe₂O₄, ZnFe₂O₄, MnₓCo₃₋ₓO₄ (where, x is a positive real number of 3 or less) in spinel-based ferrite system, bismuth ferrite (BiFeO₃), bismuth zinc niobate (Bi_{1.5}Zn₁Nb_{1.5}O₇), lithium aluminum titanium phosphate glass ceramic, metal oxide such as Li—La—Zr—O based garnet oxide, Li—La—Ti—O based perovskite oxide, La—Ni—O based oxide, lithium iron phosphate, lithium-cobalt oxide, Li—Mn—O based spinel oxide (lithium-manganese oxide), lithium aluminum germanium phosphate, tungsten oxide, tin oxide, lanthanum nickelate, lanthanum-strontium-manganese oxide, lanthanum-strontium-iron-cobalt oxide, silicate-based phosphor, SiAlON-based phosphor, metal nitride such as aluminum nitride, silicon nitride, titanium nitride, AlON, metal carbide such as silicon carbide, titanium carbide, tungsten carbide, metal boride such as magnesium boride, titanium boride, metal oxide/metal nitride composite, metal oxide/metal carbide composite, ceramic/polymer composite, ceramic/metal composite, metals such as nickel, tungsten and copper, semi-metals such as silicon, or a mixture thereof.

Further, the granules of a brittle material according to the present invention may contain 0.1 to 10 μm pores. Through the pores, such materials as drugs including antibiotics and growth factor protein may be interfused. Accordingly, the granules of a brittle material according to the present invention may contain the drugs, the growth factor protein, or such, and thus may be applicable to the field of pharmacy.

The present invention provides a method for forming a coating film of a brittle material, which includes the following steps of:

a material preparing step at which the granules of a brittle material are charged into a feeder and a substrate is arranged in a vacuum chamber (step 1);

a gas supplying step at which the granules of the brittle material and the carrier gas are mixed together (step 2); and

a granule injecting step at which the carrier gas and the granules of the brittle material mixed at step 2 are transported to a nozzle and injected onto the substrate of step 1 through the nozzle (step 3).

The method for forming the coating film of a brittle material according to the present invention can be performed by using the coating apparatus provided in FIG. 2 of the Korean Patent No. 10-2011-0044543, but not limited thereto. Accordingly, the general aerosol deposition apparatus may be modified for the purpose of granule injection.

Hereinafter, the method for forming a coating film of a brittle material will be described in detail by steps.

In the method for forming a coating film of a brittle material according to the present invention, step 1 is to charge the granules of a brittle material into a feeder and arrange a substrate in a chamber in vacuum. Therefore, the granules of a brittle material as a raw material and the substrate to be coated need to be charged and arranged in the coating apparatus.

The granules of a brittle material at step 1 can be prepared by the preparation process, which includes the following steps of:

mixing the brittle material powder whose particulate size is 0.1-6 μm with a solvent and adding a binder to prepare slurry (step a); and

granulating the slurry prepared at step a (step b).

The step a is to prepare slurry by mixing the powder of brittle material particles sized in 0.1 to 6 μm, as a raw material of the granules, with a solvent and adding a binder. The binder may differ in types or contents depending on the composition or particle size of the powder of brittle material particles. However, polyvinyl alcohol (PVA), polyacrylic acid (PAA), 2-octanol, polyvinyl butyral (PVB), polyethylene glycol (PEG), or a mixture thereof may be used as the binder. Although the binder may be added in different amount depending on the type of the binder used for the powder of brittle material particles, the binder may be added in the amount of 0.2-3.0 wt %. However, the added amount is not limited to any specific example. If the binder is added less than the above range, the bonding between the particles becomes weaker so that controlling the forms of the brittle material granules can be challenging. On the contrary, if the binder is added above said range, granulation yield may deteriorate due to an excessive use of the binder and the cost for preparation may increase.

Water may be used for solvent, or organic solvent may be used, such as ethanol, methanol, acetone, isopropyl alcohol, ethylacetate, or methyl ethyl ketone. Further, the weight ratio of 5-8:2-5 is desirable for mixing the powder of the brittle material particles with the solvent. As for the range of the weight ratio, the weight ratio of the powder can be increased up to 8 to increase the yield, but not limited thereto.

When water (e.g., distilled water) is used as the solvent, a dispersing agent and antifoaming agent can be further added. When organic solvent is used as the solvent, controlling viscosity and concentration may be easier without requiring use of the dispersing agent or antifoaming agent, and thus the prepared granules may be more suitable for the injection through a nozzle. However, when water is used, it may be difficult to control the viscosity and concentration of the slurry. Therefore, the addition of the dispersing agent and antifoaming agent may be desirable for the injection of the granules through a nozzle, but not limited thereto.

The step b is to granulate the slurry prepared at the step a. The slurry prepared at step 1 contains a large amount of the binder and can be granulated through ball milling and spray drying. At this time, the binding force between the particles can be maintained intact by the organic binder. Through the granulation, the granules of a brittle material according to the present invention may be prepared. However, even if the granules of a brittle material are composed of the particles adhered to each other by the binder, the granules may present a desirable strength (compressive strength) for the room-temperature granule spray in vacuum and thus may form a dense coating film through the injection.

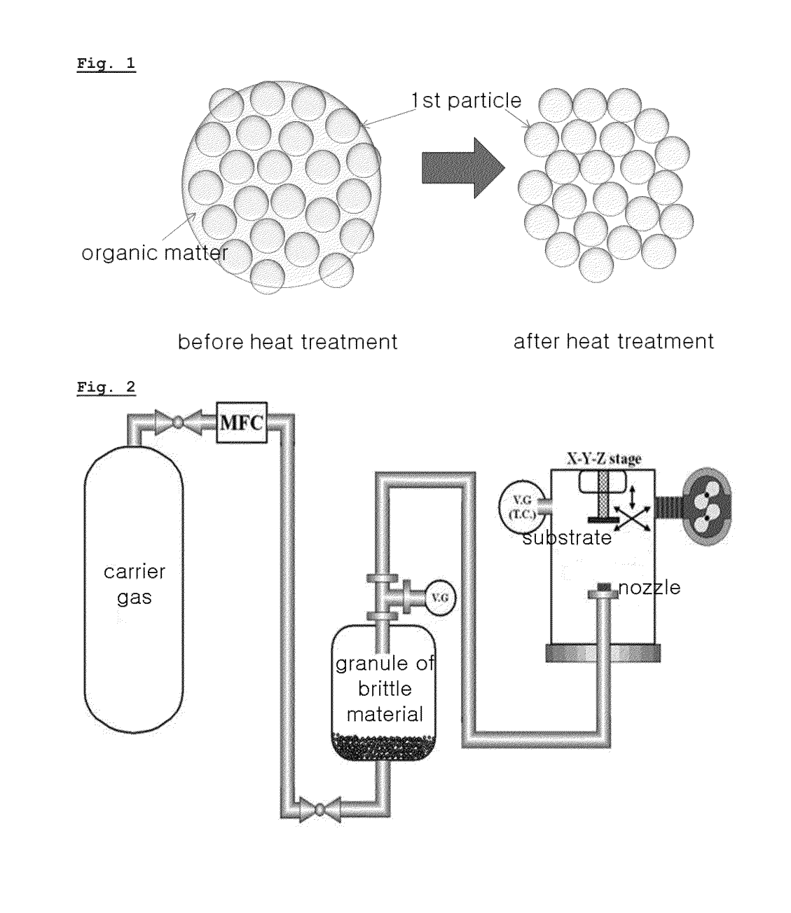

After the granulation at the step b, the granulated granules of a brittle material can be used without heat treatment. However, if the organic matter used as the binder remains heavily, the heat treatment can be performed for the granulated granules of a brittle material to remove the residuals. The heat treatment can be performed at 200-1500° C. for 1-24 hours. Through this, the binder present in the granules of a brittle material may be removed and the granules having a proper strength may be prepared. If, the heat treatment temperature is less than 200° C., the binder for the granules of a brittle material may be partially remained. On the contrary, if the heat treatment temperature is over 1500° C., the granules of a brittle material may be excessively sintered and an excessive amount of energy may be consumed. Further, the heat treatment temperature may optimally be designed according to the constituent and size of the powder of brittle material particles (e.g., hydroxyapatite: 500-1200° C., PZT: 400-900° C., Y₂O₃: 500-1500° C., YSZ: 500-1500° C.). FIG. 1 is a schematic drawing illustrating the condensation states of brittle material granules before and after heat treatment. Before the heat treatment, the particles of brittle material powder are bound together by a binder. After the heat treatment, the primary fine particles remain bound, after the binder is removed.

Further, the granules of a brittle material at step 1 may be prepared by the method including the following steps of:

preparing slurry by mixing the powder of brittle material particles sized to 0.1 to 6 μm, polymer, and a solvent, and adding a binder (step a);

granulating the slurry prepared at the step a (step b); and

removing the polymer from the granules by thermally treating the granules granulated at the step b (step c).

The step a is to prepare slurry by mixing the powder of brittle material particles sized in 0.1 to 6 μm, as a raw material for the granules of the brittle material, with polymer and a solvent, and adding a binder. The type and content of the binder can be changed according to the composition of the powder and the size of the particles, but the following can be used as the binder—polyvinyl alcohol (PVA), polyacrylic acid (PAA), 2-octanol, polyvinyl butyral (PVB), polyethylene glycol (PEG), and a mixture thereof. Although the added amount of the binder can be different according to the type of the binder for the powder of brittle material particles, the amount in the range of 0.2-3.0 wt % can be added. However, the added amount is not limited to any specific example. If the binder is added less than the range, the bonding between the particles may be weakened and controlling the forms of the brittle material granules may be challenging. On the contrary, if the binder is added over the range, granulation yield may deteriorate due to an excessive use of the binder and the cost for preparation may increase.

Water solvent, or organic solvent can be used. Further, the weight ratio of 5-8:2-5 is desirable for mixing the powder of the brittle material particles with the solvent. As for the range of the weight ratio, the weight ratio of the powder can be increased up to 8 to increase the yield, but not limited thereto.

The polymer may include polyvinylidene fluoride, polyimide, polyethylene, polystyrene, polymethyl methacrylate, polytetra fluoroethylene, starch, or a mixture thereof. The polymer can be burn out through heat treatment. By burning the polymer out after the granulation, pores may be formed in the places where the polymers were positioned, and the particle strength may be controlled.

The step b is to granulate the slurry prepared at the step a. The slurry prepared at the step a contains a large amount of the binder and can be granulated through ball milling and spray drying. At this time, the binding force between the particles may be maintained intact by the organic binder. Through the granulation, the granules of a brittle material according to the present invention may be prepared.

The step c is to thermally treat the granules granulated at the step b, remove polymer from the granules, and form pores in the granules. At this time, the heat treatment at the step c can be performed at 200-1500° C. for 1-24 hours. Through this, the polymer may be burn out from the granules of a brittle material to form pores, and the binder remained in the granules may be removed. Through the pores formed at the step 3, such materials as drugs including antibiotics and growth factor protein may be interfused. Based on this, the granules of a brittle material according to the present invention may be applicable to the field of pharmacy.

In addition, the granules of a brittle material may contain the pores which are 0.1 to 10 μm in size. Through these pores, such materials as drugs including antibiotics and growth factor protein may be interfused, and the granules of a brittle material may contain the drugs and growth factor protein.

In the method for forming a coating film of a brittle material according to the present invention, step 2 is to supply carrier gas to mix the granules of a brittle material with the carrier gas. To form a coating film by injecting the granules of a brittle material as a raw material, a carrier gas is used to transport the granules of a brittle material to a nozzle. For this, the carrier gas is supplied and thereby the granules of brittle material are mixed with the carrier gas to be dispersed. As a result, sufficient flowability may be obtained to transport the granules of a brittle material to the nozzle.

The carrier gas can be additionally injected to obtain kinetic energy sufficient for the granules, but not limited thereto.

Since the granules of a brittle material have a desirable flowability and a larger mass compared to the raw powder used for a fine powder injection, the granules do not need an excessive amount of carrier gas and therefore the granules may be transported to the nozzle even with a relatively small amount of carrier gas supplied.

In the method for forming a coating film of a brittle material according to the present invention, step 3 is to inject the granules onto the substrate of step 1 through a nozzle after transporting the carrier gas and the granules of a brittle material mixed at step 2.

At the time when the granules are injected through the nozzle at step 3, the flow rate of the carrier gas is desirably in the range of 0.1-6 L/min per 1 mm² of the nozzle slit area, but not limited thereto. To inject the fine powder used for aerosol deposition through a nozzle, the flow rate of the carrier gas should be 2 L/min or more per 1 mm² of the nozzle slit area (if other conditions are the same as in the room-temperature granule spray in vacuum of the present invention) so that a coating film may be prepared. However, since the granules of a brittle material have more desirable flowability than powder, an excessive amount of the carrier gas is not required. Further, since the mass of the brittle material granules is larger than the general powder, a higher kinetic energy may be obtained so that a coating film may be prepared at an improved forming rate, even with the gas flow rate of 1 L/min per 1 mm² of the nozzle slit area or less (refer to Experimental Example 3.). Furthermore, the granules of a brittle material enable continuous coating because the granules can be supplied continuously, unlike the powder.

As stated above, the method for forming a coating film according to the present invention can be performed by injecting the granules of a brittle material, as a raw material, onto a substrate through a nozzle. The granules are injected onto the substrate in a state where the mean diameter of the granules is 5 to 500 μm. The granules are injected through the nozzle, without requiring an additional disintegrating process, to collide against the substrate in the same size as before the injection and form a coating film. By forming the coating film using the granules of a brittle material as a raw material, agglomeration of the raw material, which occurred when the fine particle powder is used as a raw material for the conventional room-temperature vacuum injection, is prevented and the quality of the resultant coating film may be improved.

Further, the present invention provides a coating film of a brittle material prepared by the method for forming the coating film.

The coating film is prepared with the method for forming the coating film by injecting the granules of a brittle material whose mean diameter is 5-500 μm and compressive strength is 0.05-20 MPa directly onto a substrate under vacuum condition, without an additional disintegrating process. By injecting the granules of a brittle material directly to prepare the coating film of the brittle material, the coating film having a dense and fine structure with porosity of 10% or less, without cracks and micron-sized pores, may be prepared. In addition, the coating film may have the fine structure with no lamella (refer to Experimental Example 5.).

Further, if the granules of a brittle material, as a raw material, contain drugs such as antibiotics and growth factor protein, the coating film of the brittle material may be used for composite coating for drug-releasing implant and multifunctional device. Furthermore, if the granules of a brittle material, as a raw material, contain PVDF, polyimide, polyethylene, polystyrene, PMMA, starch, or such, the porous coating film may be obtained by removing the substances above.

Hereinafter, the present invention will be described in greater detail with examples. However, the following examples are intended only to be illustrative, and not to limit the scope of the claims.

### Example 1

### Preparation of Pb(Zr,Ti)O₃ Granules 1

Pb(Zr,Ti)O₃ powder and water were mixed at a weight ratio of 1:1. For the Pb(Zr,Ti)O₃ powder, 2 wt % polyvinyl alcohol, 0.5 wt % polyacrylic acid, and 0.3 wt % 2-octanol were added as a binder to prepare slurry. After ball milling and spray drying the prepared slurry, Pb(Zr,Ti)O₃ granules were prepared.

### Example 2

### Preparation of Pb(Zr,Ti)O₃ Granules 2

Pb(Zr,Ti)O₃ powder and water were mixed at a weight ratio of 1:1. For the Pb(Zr,Ti)O₃ powder, 2 wt % polyvinyl alcohol, 0.5 wt % polyacrylic acid, and 0.3 wt % 2-octanol were added as a binder to prepare slurry. After ball milling and spray drying the prepared slurry, heat treatment was performed at 500° C. for 5 hours and thereby Pb(Zr,Ti)O₃ granules were prepared.

### Example 3

### Preparation of Pb(Zr,Ti)O₃ Granules 3

Pb(Zr,Ti)O₃ granules were prepared by the same method as presented in Example 2, except for the difference from Example 2 that heat treatment was performed at 500° C. for 10 hours.

### Example 4

### Preparation of Pb(Zr,Ti)O₃ Granules 4

Pb(Zr,Ti)O₃ granules were prepared by the same method as presented in Example 2, except for the difference from Example 2 that heat treatment was performed at 600° C. for 5 hours.

### Example 5

### Preparation of Pb(Zr,Ti)O₃ Granules 5

Pb(Zr,Ti)O₃ granules were prepared by the same method as presented in Example 2, except for the difference from Example 2 that heat treatment was performed at 600° C. for 10 hours.

### Example 6

### Preparation of Pb(Zr,Ti)O₃ Granules 6

Pb(Zr,Ti)O₃ granules were prepared by the same method as presented in Example 2, except for the difference from Example 2 that heat treatment was performed at 650° C. for 5 hours.

### Example 7

### Preparation of Pb(Zr,Ti)O₃ Granules 7

Pb(Zr,Ti)O₃ granules were prepared by the same method as presented in Example 2, except for the difference from Example 2 that heat treatment was performed at 700° C. for 5 hours.

### Example 8

### Preparation of Pb(Zr,Ti)O₃ Granules 8

Pb(Zr,Ti)O₃ granules were prepared by the same method as presented in Example 2, except for the difference from Example 2 that heat treatment was performed at 700° C. for 6 hours.

### Example 9

### Preparation of Pb(Zr,Ti)O₃ Granules 9

Pb(Zr,Ti)O₃ granules were prepared by the same method as presented in Example 2, except for the difference from Example 2 that heat treatment was performed at 800° C. for 5 hours.

### Example 10

### Preparation of Pb(Zr,Ti)O₃ Granules 10

Pb(Zr,Ti)O₃ granules were prepared by the same method as presented in Example 2, except for the difference from Example 2 that heat treatment was performed at 900° C. for 5 hours.

### Example 11

### Preparation of Pb(Zr,Ti)O₃ Granules 11

Pb(Zr,Ti)O₃ granules were prepared by the same method as presented in Example 2, except for the difference from Example 2 that heat treatment was performed at 1200° C. for 5 hours.

### Example 12

### Preparation of TiO₂ Granules 1

TiO₂ granules were prepared by the same method as presented in Example 1, except for the difference from Example 1 that TiO₂ powder was used instead of Pb(Zr,Ti)O₃ powder.

### Example 13

### Preparation of TiO₂ Granules 2

TiO₂ granules were prepared by the same method as presented in Example 2, except for the difference from Example 2 that TiO₂ powder was used instead of Pb(Zr,Ti)O₃ powder.

### Example 14

### Preparation of TiO₂ Granules 3

TiO₂ granules were prepared by the same method as presented in Example 13, except for the difference from Example 13 that heat treatment was performed at 600° C.

### Example 15

### Preparation of TiO₂ Granules 4

TiO₂ granules were prepared by the same method as presented in Example 13, except for the difference from Example 13 that heat treatment was performed at 700° C. for 2 hours.

### Example 16

### Preparation of TiO₂ Granules 5

TiO₂ granules were prepared by the same method as presented in Example 13, except for the difference from Example 13 that heat treatment was performed at 800° C. for 2 hours.

### Example 17

### Preparation of TiO₂ Granules 6

TiO₂ granules were prepared by the same method as presented in Example 13, except for the difference from Example 13 that heat treatment was performed at 900° C.

### Example 18

### Preparation of TiO₂ Granules 7

TiO₂ granules were prepared by the same method as presented in Example 13, except for the difference from Example 13 that heat treatment was performed at 1000° C.

### Example 19

### Preparation of Yttria-Stabilized Zirconia (YSZ) Granules 1

Yttria-stabilized zirconia (YSZ) granules were prepared by the same method as presented in Example 1, except for the difference from Example 1 that yttria-stabilized zirconia (YSZ) powder was used instead of Pb(Zr,Ti)O₃ powder.

### Example 20

### Preparation of Yttria-Stabilized Zirconia (YSZ) Granules 2

Yttria-stabilized zirconia (YSZ) granules were prepared by the same method as presented in Example 19, except for the difference from Example 19 that heat treatment was performed at 600° C. for 2 hours.

### Example 21

### Preparation of Yttria-Stabilized Zirconia (YSZ) Granules 3

Yttria-stabilized zirconia (YSZ) granules were prepared by the same method as presented in Example 20, except for the difference from Example 20 that heat treatment was performed at 800° C.

### Example 22

### Preparation of Yttria-Stabilized Zirconia (YSZ) Granules 4

Yttria-stabilized zirconia (YSZ) granules were prepared by the same method as presented in Example 20, except for the difference from Example 20 that heat treatment was performed at 1000° C.

### Example 23

### Preparation of Gadolinia-Doped Ceria (GDC) Granules 1

Gadolinia-doped ceria (GDC) granules were prepared by the same method as presented in Example 1, except for the difference from Example 1 that gadolinia-doped ceria (GDC) powder was used instead of Pb(Zr,Ti)O₃ powder.

### Example 24

### Preparation of Gadolinia-Doped Ceria (GDC)/Gadolinia (Gd₂O₃) Granules 1

Gadolinia-doped ceria (GDC)/gadolinia (Gd₂O₃) granules were prepared by the same method as presented in Example 1, except for the difference from Example 1 that gadolinia-doped ceria (GDC) powder and gadolinia (Gd₂O₃) powder (4 wt %) were mixed to be used instead of Pb(Zr,Ti)O₃ powder.

### Example 25

### Preparation of Gadolinia-Doped Ceria (GDC)/Gadolinia (Gd₂O₃) Granules 2

Gadolinia-doped ceria (GDC)/gadolinia (Gd₂O₃) granules were prepared by the same method as presented in Example 24, except for the difference from Example 24 that the gadolinia-doped ceria (GDC)/gadolinia (Gd₂O₃) granules of Example 24 were thermally treated at 600° C. for 2 hours.

### Example 26

### Preparation of Gadolinia-Doped Ceria (GDC)/Gadolinia (Gd₂O₃) Granules 3

Gadolinia-doped ceria (GDC)/gadolinia (Gd₂O₃) granules were prepared by the same method as presented in Example 24, except for the difference from Example 24 that the gadolinia (Gd₂O₃) powder of Example 24 was mixed at a ratio of 10 wt %.

### Example 27

### Preparation of Gadolinia-Doped Ceria (GDC)/Gadolinia (Gd₂O₃) Granules 4

Gadolinia-doped ceria (GDC)/gadolinia (Gd₂O₃) granules were prepared by the same method as presented in Example 26, except for the difference from Example 26 that the gadolinia-doped ceria (GDC)/gadolinia (Gd₂O₃) granules of Example 26 were thermally treated at 800° C. for 2 hours.

### Example 28

### Preparation of Gadolinia-Doped Ceria (GDC)/Gadolinia (Gd₂O₃) Granules 5

Gadolinia-doped ceria (GDC)/gadolinia (Gd₂O₃) granules were prepared by the same method as presented in Example 26, except for the difference from Example 26 that the gadolinia-doped ceria (GDC)/gadolinia (Gd₂O₃) granules of Example 26 were thermally treated at 1000° C. for 2 hours.

### Example 29

### Preparation of Tungsten Carbide (WC) Granules 1

Tungsten carbide (WC) powder and ethanol as an organic solvent were mixed at a weight ratio of 1:1. For the tungsten carbide (WC) powder, polyvinyl butyral (PVB) was added at a ratio of 1 wt % to prepare slurry. After spray drying the prepared slurry, tungsten carbide (WC) granules were prepared.

### Example 30

### Preparation of Tungsten Carbide (WC) Granules 2

Tungsten carbide (WC) granules were prepared by the same method as presented in Example 29, except for the difference from Example 29 that the tungsten carbide (WC) granules of Example 29 were thermally treated at 700° C. for 3 hours under an ultra-pure argon atmosphere.

### Example 31

### Preparation of Aluminum Nitride (AlN) Granules 1

Aluminum nitride (AlN) granules were prepared by the same method as presented in Example 29, except for the difference from Example 29 that aluminum nitride (AlN) powder was used instead of tungsten carbide (WC) powder.

### Example 32

### Preparation of Aluminum Nitride (AlN) Granules 2

Aluminum nitride (AlN) granules were prepared by the same method as presented in Example 31, except for the difference from Example 31 that the aluminum nitride (AlN) granules of Example 31 were thermally treated at 500° C. for 2 hours under nitrogen atmosphere.

### Example 33

### Preparation of Aluminum Nitride (AlN) Granules 3

Aluminum nitride (AlN) granules were prepared by the same method as presented in Example 32, except for the difference from Example 32 that heat treatment was performed at 600° C. for 2 hours under nitrogen atmosphere.

### Example 34

### Preparation of Aluminum Nitride (AlN) Granules 4

Aluminum nitride (AlN) granules were prepared by the same method as presented in Example 32, except for the difference from Example 32 that heat treatment was performed at 800° C. for 2 hours under nitrogen atmosphere.

### Example 35

### Preparation of Aluminum Nitride (AlN) Granules 5

Aluminum nitride (AlN) granules were prepared by the same method as presented in Example 32, except for the difference from Example 32 that heat treatment was performed at 1000° C. for 2 hours under nitrogen atmosphere.

### Example 36

### Preparation of Aluminum Boride (AlB₁₂) Granules 1

Aluminum boride (AlB₁₂) granules were prepared by the same method as presented in Example 29, except for the difference from Example 29 that aluminum boride (AlB₁₂) powder was used instead of tungsten carbide (WC) powder.

### Example 37

### Preparation of Aluminum Boride (AlB₁₂) Granules 2

Aluminum boride (AlB₁₂) granules were prepared by the same method as presented in Example 36, except for the difference from Example 36 that the aluminum boride (AlB₁₂) granules of Example 36 were thermally treated at 700° C. for 3 hours under an ultra-pure argon atmosphere.

### Example 38

### Preparation of Lanthanum Boride (LaB₆) Granules 1

Lanthanum boride (LaB₆) granules were prepared by the same method as presented in Example 29, except for the difference from Example 29 that lanthanum boride (LaB₆) powder was used instead of tungsten carbide (WC) powder.

### Example 39

### Preparation of Lanthanum Boride (LaB₆) Granules 2

Lanthanum boride (LaB₆) granules were prepared by the same method as presented in Example 38, except for the difference from Example 38 that the lanthanum boride (LaB₆) granules of Example 38 were thermally treated at 700° C. for 3 hours under an ultra-pure argon atmosphere.

### Example 40

### Preparation of Silicon (Si) Granules 1

Silicon (Si) granules were prepared by the same method as presented in Example 1, except for the difference from Example 1 that silicon (Si) powder was used instead of Pb(Zr,Ti)O₃ powder.

### Example 41

### Preparation of Silicon (Si) Granules 2

Silicon (Si) granules were prepared by the same method as presented in Example 40, except for the difference from Example 40 that the silicon (Si) granules of Example 40 were thermally treated at 700° C. for 2 hours under an ultra-pure argon atmosphere.

### Example 42

### Preparation of Molybdenum Disulfide (MoS₂) Granules 1

Molybdenum disulfide (MoS₂) granules were prepared by the same method as presented in Example 29, except for the difference from Example 29 that molybdenum disulfide (MoS₂) powder was used instead of tungsten carbide (WC) powder.

### Example 43

### Preparation of Yttria (Y₂O₃) Granules 1

Yttria (Y₂O₃) granules were prepared by the same method as presented in Example 1, except for the difference from Example 1 that yttria (Y₂O₃) powder was used instead of Pb(Zr,Ti)O₃ powder.

### Example 44

### Preparation of Yttria (Y₂O₃) Granules 2

Yttria (Y₂O₃) granules were prepared by the same method as presented in Example 43, except for the difference from Example 43 that the yttria (Y₂O₃) granules of Example 43 were thermally treated at 1000° C. for 2 hours.

### Example 45

### Preparation of Yttria (Y₂O₃) Granules 3

Yttria (Y₂O₃) granules were prepared by the same method as presented in Example 44, except for the difference from Example 44 that heat treatment was performed at 1050° C.

### Example 46

### Preparation of Yttria (Y₂O₃) Granules 4

Yttria (Y₂O₃) granules were prepared by the same method as presented in Example 44, except for the difference from Example 44 that heat treatment was performed at 1100° C.

### Example 47

### Preparation of Yttria (Y₂O₃) Granules 5

Yttria (Y₂O₃) granules were prepared by the same method as presented in Example 44, except for the difference from Example 44 that heat treatment was performed at 1150° C.

### Example 48

### Preparation of Yttria (Y₂O₃) Granules 6

Yttria (Y₂O₃) granules were prepared by the same method as presented in Example 44, except for the difference from Example 44 that heat treatment was performed at 1200° C.

### Example 49

### Preparation of Hydroxyapatite (HA) Granules 1

Hydroxyapatite (HA) granules were prepared by the same method as presented in Example 1, except for the difference from Example 1 that hydroxyapatite (HA) powder was used instead of Pb(Zr,Ti)O₃ powder.

### Example 50

### Preparation of Hydroxyapatite (HA) Granules 2

Hydroxyapatite (HA) granules were prepared by the same method as presented in Example 49, except for the difference from Example 49 that the hydroxyapatite (HA) granules of Example 49 were thermally treated at 600° C. for 1 hour.

### Example 51

### Preparation of Hydroxyapatite (HA) Granules 3

Hydroxyapatite (HA) granules were prepared by the same method as presented in Example 49, except for the difference from Example 49 that the hydroxyapatite (HA) granules of Example 49 were thermally treated at 1100° C. for 2 hours.

### Example 52

### Preparation of Hydroxyapatite (HA) Granules 4

Hydroxyapatite (HA) granules were prepared by the same method as presented in Example 50, except for the difference from Example 50 that a mixture of hydroxyapatite (HA) powder and polymethyl methacrylate (PMMA) was used. Porous hydroxyapatite granules were prepared with polymethyl methacrylate (PMMA) eliminated during the heat treatment.

### Example 53

### Preparation of Aluminum Oxide (Al₂O₃) Granules 1

Aluminum oxide (Al₂O₃) granules were prepared by the same method as presented in Example 1, except for the difference from Example 1 that aluminum oxide (Al₂O₃) powder was used instead of Pb(Zr,Ti)O₃ powder.

Table 1 below shows the conditions (types of raw materials, heat treatment temperature, and heat treatment time) under which the granules of the brittle materials were prepared as presented in Examples 1 to 53.

TABLE 1

| | | Heat | Heat |
|---|---|---|---|
| | | Treatment | Treatment |
| | | Temperature | Time |
| | Type of Raw Powder | (° C.) | (hr) |
| Ex. 1 | Pb(Zr,Ti)O₃ | — | — |
| Ex. 2 | Pb(Zr,Ti)O₃ | 500 | 5 |
| Ex. 3 | Pb(Zr,Ti)O₃ | 500 | 10 |
| Ex. 4 | Pb(Zr,Ti)O₃ | 600 | 5 |
| Ex. 5 | Pb(Zr,Ti)O₃ | 600 | 10 |
| Ex. 6 | Pb(Zr,Ti)O₃ | 650 | 5 |
| Ex. 7 | Pb(Zr,Ti)O₃ | 700 | 5 |
| Ex. 8 | Pb(Zr,Ti)O₃ | 700 | 6 |
| Ex. 9 | Pb(Zr,Ti)O₃ | 800 | 5 |
| Ex. 10 | Pb(Zr,Ti)O₃ | 900 | 5 |
| Ex. 11 | Pb(Zr,Ti)O₃ | 1200 | 5 |
| Ex. 12 | TiO₂ | — | — |
| Ex. 13 | TiO₂ | 500 | 5 |
| Ex. 14 | TiO₂ | 600 | 5 |
| Ex. 15 | TiO₂ | 700 | 2 |
| Ex. 16 | TiO₂ | 800 | 2 |
| Ex. 17 | TiO₂ | 900 | 5 |
| Ex. 18 | TiO₂ | 1000 | 5 |
| Ex. 19 | Yttria-stabilized | — | — |
| | Zirconia (YSZ) | | |
| Ex. 20 | Yttria-stabilized | 600 | 2 |
| | Zirconia (YSZ) | | |
| Ex. 21 | Yttria-stabilized | 800 | 2 |
| | Zirconia (YSZ) | | |
| Ex. 22 | Yttria-stabilized | 1000 | 2 |
| | Zirconia (YSZ) | | |
| Ex. 23 | GDC | — | — |
| Ex. 24 | GDC/Gd₂O₃ | — | — |
| Ex. 25 | GDC/Gd₂O₃ | 600 | 2 |
| Ex. 26 | GDC/Gd₂O₃ | — | — |
| Ex. 27 | GDC/Gd₂O₃ | 800 | 2 |
| Ex. 28 | GDC/Gd₂O₃ | 1000 | 2 |
| Ex. 29 | Tungsten Carbide (WC) | — | — |
| Ex. 30 | Tungsten Carbide (WC) | 700 | 3 |
| Ex. 31 | Aluminum Nitride (AlN) | — | — |
| Ex. 32 | Aluminum Nitride (AlN) | 500 | 2 |
| Ex. 33 | Aluminum Nitride (AlN) | 600 | 2 |
| Ex. 34 | Aluminum Nitride (AlN) | 800 | 2 |
| Ex. 35 | Aluminum Nitride (AlN) | 1000 | 2 |
| Ex. 36 | Aluminum Boride (AlB₁₂) | — | — |
| Ex. 37 | Aluminum Boride (AlB₁₂) | 700 | 3 |
| Ex. 38 | Lanthanum Boride (LaB₆) | — | — |
| Ex. 39 | Lanthanum Boride (LaB₆) | 700 | 3 |
| Ex. 40 | Silicon (Si) | — | — |
| Ex. 41 | Silicon (Si) | 700 | 2 |
| Ex. 42 | Molybdenum Disulfide (MoS₂) | — | — |
| Ex. 43 | Yttria (Y₂O₃) | — | — |
| Ex. 44 | Yttria (Y₂O₃) | 1000 | 2 |
| Ex. 45 | Yttria (Y₂O₃) | 1050 | 2 |
| Ex. 46 | Yttria (Y₂O₃) | 1100 | 2 |
| Ex. 47 | Yttria (Y₂O₃) | 1150 | 2 |
| Ex. 48 | Yttria (Y₂O₃) | 1200 | 2 |
| Ex. 49 | Hydroxyapatite (HA) | — | — |
| Ex. 50 | Hydroxyapatite (HA) | 600 | 1 |
| Ex. 51 | Hydroxyapatite (HA) | 1100 | 2 |
| Ex. 52 | Hydroxyapatite (HA) | 600 | 1 |
| Ex. 53 | Aluminum Oxide (Al₂O₃) | — | — |

### Examples 54-82

### Preparation of Coating Films of the Brittle Materials

Coating films of the brittle materials were prepared by feeding the granules of the brittle materials prepared in the Examples above into the room-temperature granule spray in vacuum apparatus schematically shown in FIG. 2, and then injecting the granules of the brittle materials onto a substrate through a nozzle.

Table 2 below shows the room-temperature granule spray in vacuum conditions with which the coating films of the brittle materials were prepared.

TABLE 2

| | Type of | Carrier | Substrate | | |
|---|---|---|---|---|---|
| | Brittle | Gas Flow | Traveling | Substrate | Nozzle |
| | Material | Rate | Speed | Shuttling | Area |
| | Granules | (L/min.) | (mm/sec.) | Number | (mm²) |
| Ex. 54 | Pb(Zr,Ti)O₃ | 5 | 1.0 | 5 | 5 |
| | (Ex. 2) | | | | |
| Ex. 55 | Pb(Zr,Ti)O₃ | 13.5 | 1.7 | 7 | 5 |
| | (Ex. 7) | | | | |
| Ex. 56 | Pb(Zr,Ti)O₃ | 13.5 | 1.7 | 3 | 5 |
| | (Ex. 9) | | | | |
| Ex. 57 | Pb(Zr,Ti)O₃ | 13.5 | 1.7 | 3 | 5 |
| | (Ex. 10) | | | | |
| Ex. 58 | Pb(Zr,Ti)O₃ | 6.8 | 1.7 | 3 | 5 |
| | (Ex. 11) | | | | |
| Ex. 59 | TiO₂ | 6.8 | 1.7 | 5 | 5 |
| | (Ex. 12) | | | | |
| Ex. 60 | TiO₂ | 6.8 | 1.7 | 5 | 5 |
| | (Ex. 13) | | | | |
| Ex. 61 | TiO₂ | 13.5 | 1.7 | 5 | 5 |
| | (Ex. 13) | | | | |
| Ex. 62 | TiO₂ | 13.5 | 1.7 | 5 | 5 |
| | (Ex. 14) | | | | |
| Ex. 63 | TiO₂ | 6.8 | 0.5 | 5 | 5 |
| | (Ex. 15) | | | | |
| Ex. 64 | TiO₂ | 13.5 | 1.7 | 5 | 5 |
| | (Ex. 15) | | | | |
| Ex. 65 | TiO₂ | 2.1 | 0.5 | 5 | 5 |
| | (Ex. 16) | | | | |
| Ex. 66 | TiO₂ | 6.8 | 1.7 | 5 | 5 |
| | (Ex. 17) | | | | |
| Ex. 67 | TiO₂ | 6.8 | 1.7 | 5 | 5 |
| | (Ex. 18) | | | | |
| Ex. 68 | YSZ | 6.8 | 1.7 | 10 | 5 |
| | (Ex. 20) | | | | |
| Ex. 69 | YSZ | 3.4 | 1.7 | 5 | 5 |
| | (Ex. 21) | | | | |
| Ex. 70 | YSZ | 6.8 | 1.7 | 5 | 5 |
| | (Ex. 21) | | | | |
| Ex. 71 | YSZ | 13.5 | 1.7 | 5 | 5 |
| | (Ex. 21) | | | | |
| Ex. 72 | YSZ | 6.8 | 1.7 | 10 | 5 |
| | (Ex. 21) | | | | |
| Ex. 73 | YSZ | 6.8 | 1.7 | 10 | 5 |
| | (Ex. 22) | | | | |
| Ex. 74 | WC | 13.5 | 0.5 | 5 | 5 |
| | (Ex. 30) | | | | |
| Ex. 75 | AlN | 13.5 | 0.5 | 5 | 5 |
| | (Ex. 32) | | | | |
| Ex. 76 | AlN | 6.8 | 0.5 | 5 | 5 |
| | (Ex. 33) | | | | |
| Ex. 77 | AlB₁₂ | 6.8 | 0.5 | 5 | 5 |
| | (Ex. 37) | | | | |
| Ex. 78 | LaB₆ | 1.37 | 0.5 | 5 | 5 |
| | (Ex. 39) | | | | |
| Ex. 79 | Si | 3.4 | 0.03 | 3 | 2.5 |
| | (Ex. 41) | | | | |
| Ex. 80 | Si | 3.4 | 0.03 | 3 | 5 |
| | (Ex. 41) | | | | |
| Ex. 81 | MoS₂ | 0.69 | 0.5 | 5 | 5 |
| | (Ex. 42) | | | | |
| Ex. 82 | HA | 30 | 2 | 3 | 25.4 |
| | (Ex. 51) | | | | |

### Experimental Example 1

### Analysis of Average Particle Size of Raw Powder

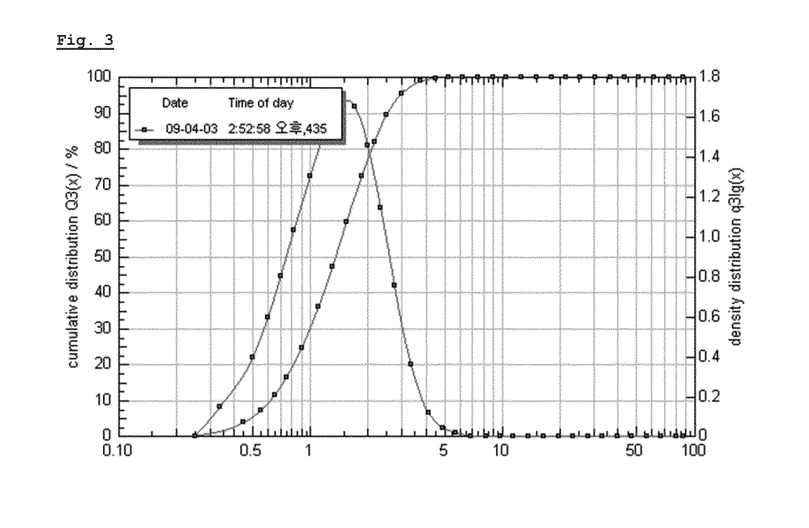

To analyze average particle size of the granules of the brittle materials and of raw powder used as a raw material for the granules of brittle materials according to the present invention, particle sizes of each raw powder were analyzed by using a particle size analyzer and scanning electron microscope. The results of the analysis are provided in FIGS. 3 to 6.

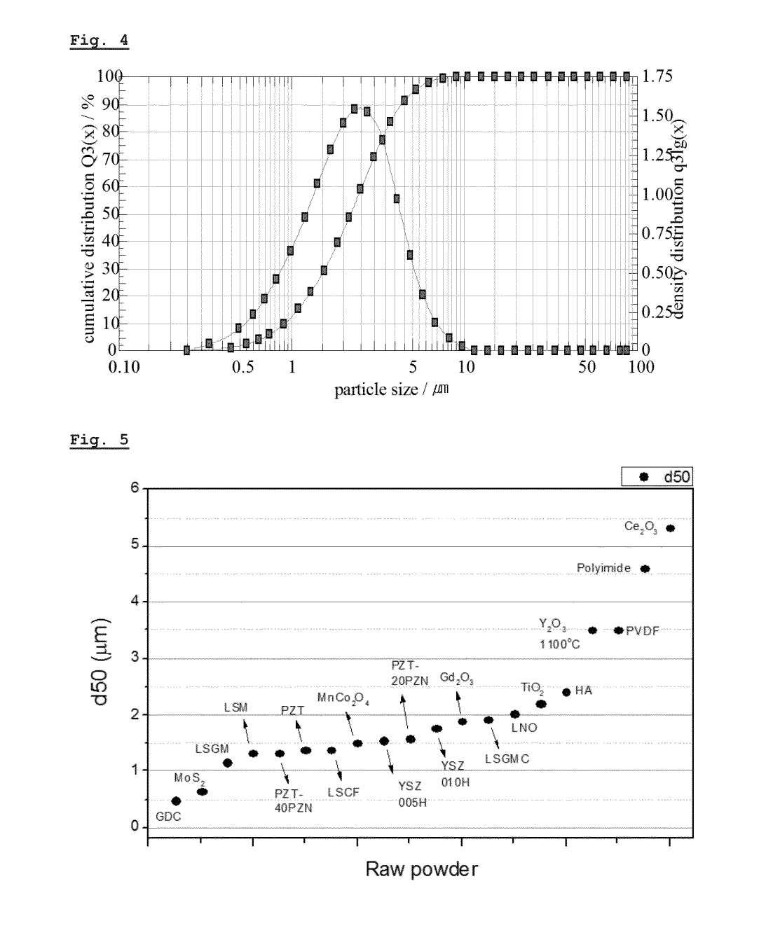

Referring to FIG. 3, the average particle size (d50) of the Pb(Zr,Ti)O₃ powder was approximately 1.36 μm. Referring to FIG. 4, the average particle size of the TiO₂ powder was approximately 2.2 μm. And referring to FIG. 5, the average particle size of the raw powders that can be used as a raw material for preparing the granules of a brittle material was in the range of 0.1 to 6 μm.

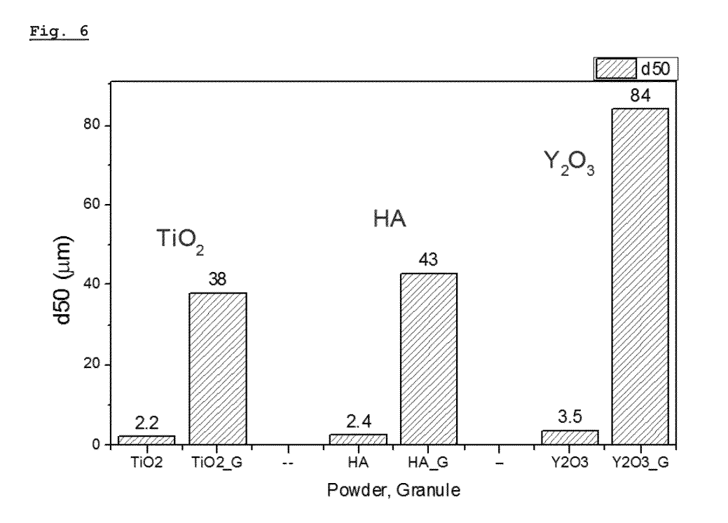

Further, as shown in FIG. 6, the size of the granules of a brittle material was larger than that of the particles of raw powder, as a result of analyzing the sizes of the granules of brittle materials and the particles of raw powders prepared in Example 12, Example 43, and Example 49. Based on this, it can be inferred that the particles of raw powder are combined to form the granules of a brittle material.

### Experimental Example 2

### Analysis of Flowability of Granules of Brittle Material

To analyze flowability of the granules of the brittle materials according to the present invention, the flowability analysis was performed by using a hall flowmeter. The results of the analysis are provided in Table 3 below.

TABLE 3

| Granule Type | Flowability (g/sec.) |
|---|---|
| Pb(Zr,Ti)O₃ (Ex. 1) | 1.67 |
| Al₂O₃ (Ex. 53) | 0.94 |
| YB₆ (granules before heat treatment) | 0.66 |
| AlB₁₂ (Ex. 36) | 0.32 |
| HA (Ex. 49) | 0.46 |
| Si (Ex. 40) | 0.13 |

Referring to Table 3 above, it was confirmed that the granules of brittle materials according to the present invention have a desirable flowability. On the contrary, the fine powder used for the conventional aerosol deposition did not have any flow and thus the flowability could not be measured. Based on this, the granules of the brittle materials according to the present invention can have a desirable flowability and therefore the granules can be transported continuously even with a relatively small amount of carrier gas.

### Experimental Example 3

### Analysis on the Possibility for Coating of Raw Powder of Brittle Material

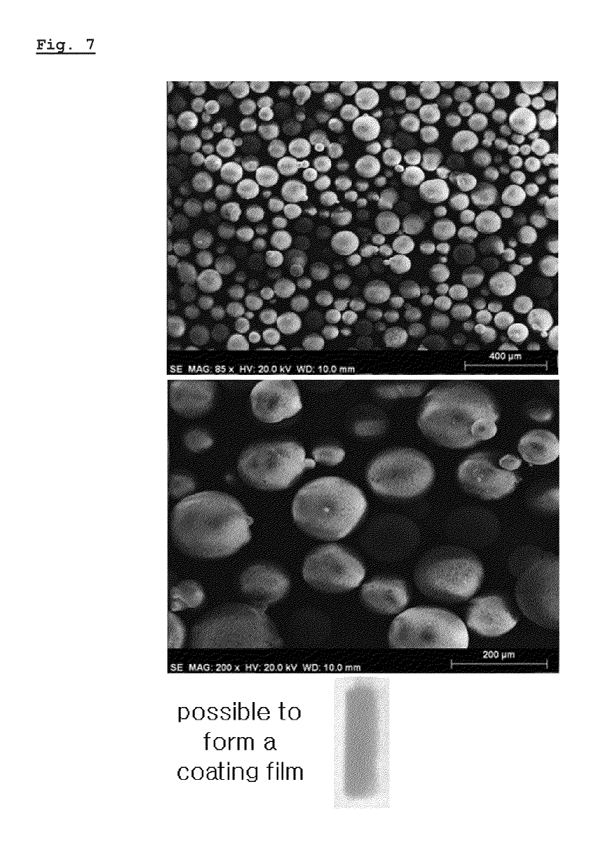

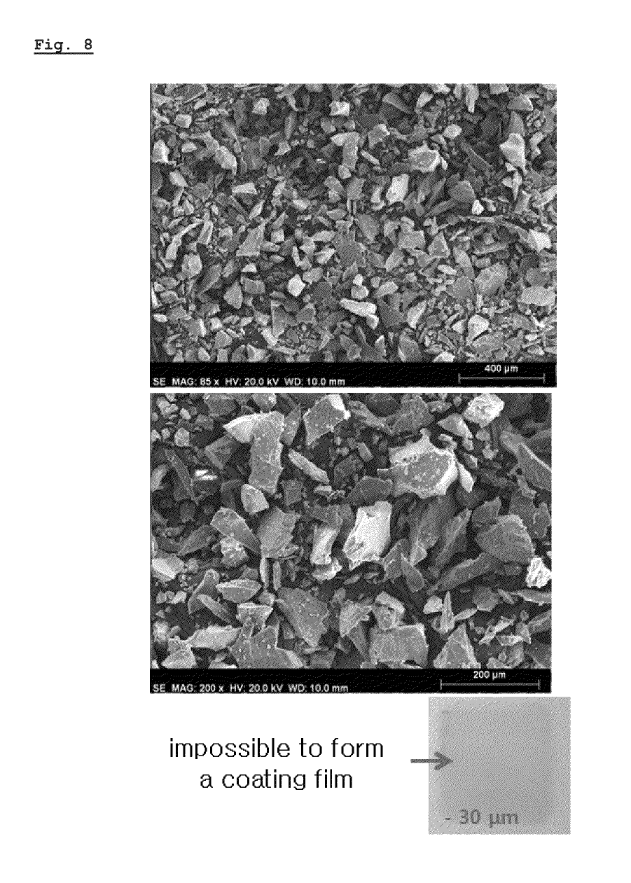

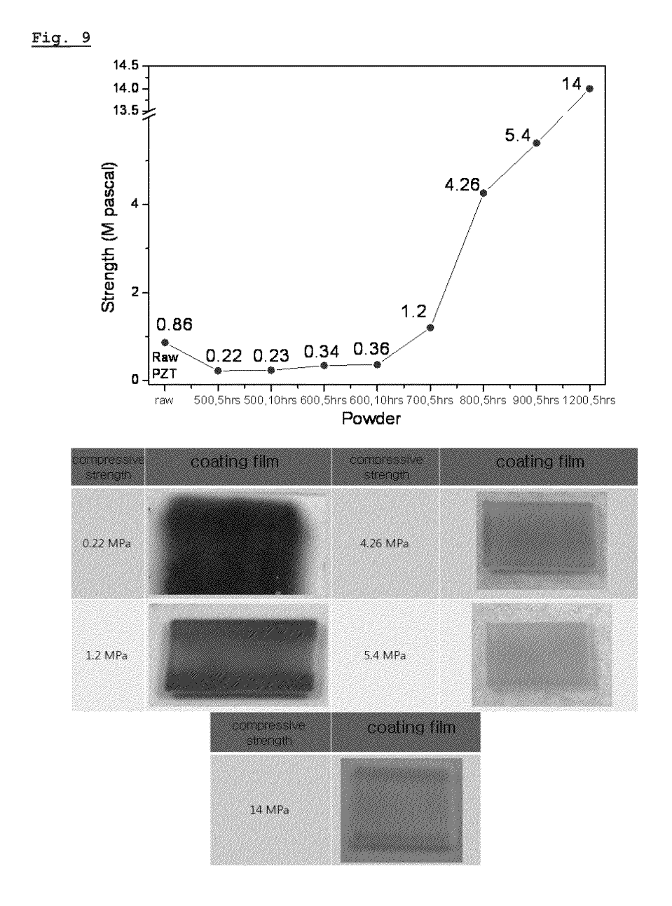

To compare the possibility for coating of the brittle material granules (Al₂O₃) prepared in Example 53 and the raw powder (Al₂O₃) whose average particle size is similar to that of the granules, the granules and the raw powder were vacuum injected at room temperature. The results thereof are provided in FIG. 7 and FIG. 8.

Referring to FIG. 7, the granules of the brittle material according to the present invention formed a coating film through the vacuum injection at room temperature. On the contrary, the raw powder having the similar average particle size to that of the granules was not able to form a coating film. In other words, the granules formed a coating film through the room-temperature granule spray in vacuum, but the raw powder whose particles are simply large did not form a coating film. Based on this, it was confirmed that the granules of a brittle material are a proper material for forming a coating film through the room-temperature granule spray in vacuum.

### Experimental Example 4

### Analysis of Compressive Strength

(1) Analysis of Compressive Strength of Pb(Zr,Ti)O₃ Granules

To measure the changes in compressive strength of Pb(Zr,Ti)O₃ granules according to heat treatment temperature, the compressive strengths of the Pb(Zr,Ti)O₃ granules were measured by using the method described in a paper (J. Kor. Ceram. Soc. Vol. 3, No. 6, 660-664 (1996)). And the results thereof are provided in Table 4 below and FIG. 9.

TABLE 4

| | Compressive Strength (MPa) |
|---|---|
| Ex. 1 | 0.86 |
| Ex. 2 | 0.22 |
| Ex. 3 | 0.23 |
| Ex. 4 | 0.34 |
| Ex. 5 | 0.36 |
| Ex. 7 | 1.2 |
| Ex. 9 | 4.26 |
| Ex. 10 | 5.4 |
| Ex. 11 | 14 |

Referring to Table 4 above, compressive strength of the Pb(Zr,Ti)O₃ granules was changed according to the heat treatment temperature presented in Examples 1 to 5, Example 5, Example 7, and Examples 9 to 11, and the compressive strength was increased when the heat treatment temperature was higher. And referring to the graph and images shown in FIG. 9, a coating film was formed even when the compressive strength of the Pb(Zr,Ti)O₃ granules was changed according to the heat treatment temperature. Based on this, it was confirmed that the compressive strength value can be controlled by properly adjusting the heat treatment temperature of the brittle material granules according to the present invention.

(2) Analysis of Compressive Strength of TiO₂ Granules

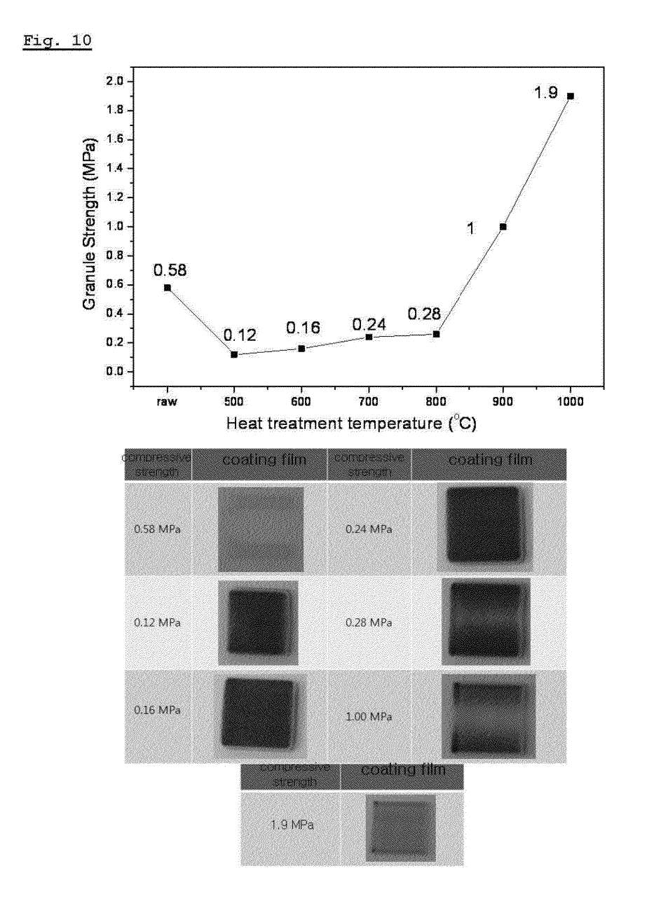

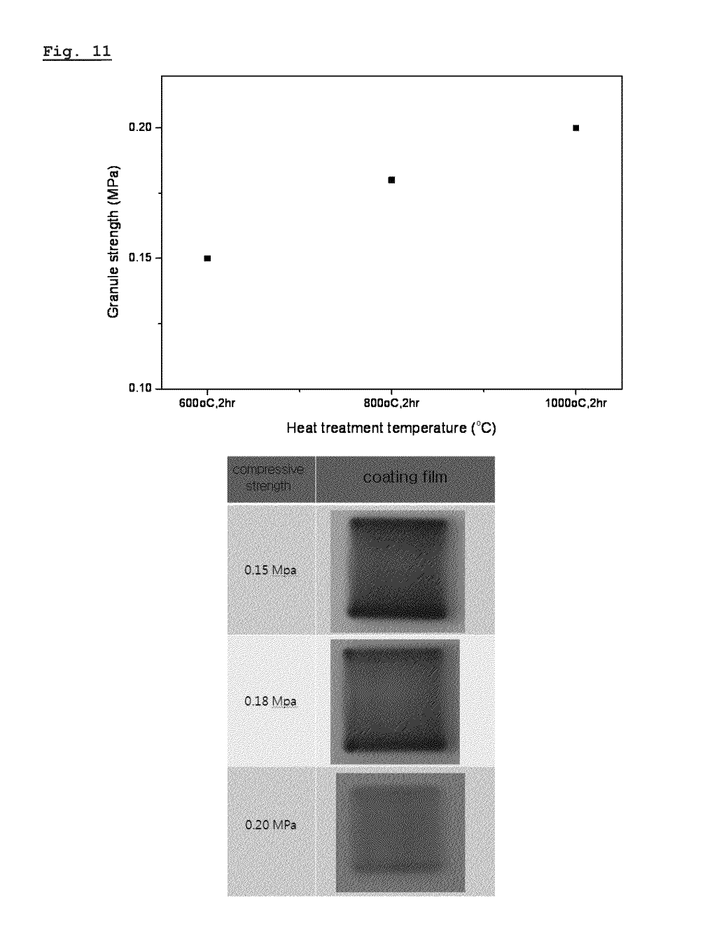

To measure the changes in compressive strength of TiO₂ granules according to heat treatment temperature, compressive strength of the TiO₂ granules was measured by using the method described in a paper (J. Kor. Ceram. Soc. Vol. 3, No. 6, 660-664 (1996)). And the results thereof are provided in Table 5 below and FIG. 10.

TABLE 5

| | Compressive Strength (MPa) |
|---|---|
| Ex. 12 | 0.58 |
| Ex. 13 | 0.12 |
| Ex. 14 | 0.16 |
| Ex. 15 | 0.24 |
| Ex. 16 | 0.28 |
| Ex. 17 | 1.00 |
| Ex. 18 | 1.90 |

Referring to Table 5 above, compressive strength of the TiO₂ granules was changed according to the heat treatment temperature presented in Examples 12 to 18, and the TiO₂ granules in Example 17 and Example 18 where the heat treatment temperature was high had a relatively higher compressive strength. And referring to the graph and images shown in FIG. 10, a coating film was formed even when the compressive strength of the TiO₂ granules was changed according to the heat treatment temperature. Based on this, it was confirmed that the compressive strength value can be controlled by properly adjusting the heat treatment temperature of the brittle material granules according to the present invention.

(3) Analysis of Compressive Strength of Yttria-stabilized Zirconia (YSZ) Granules

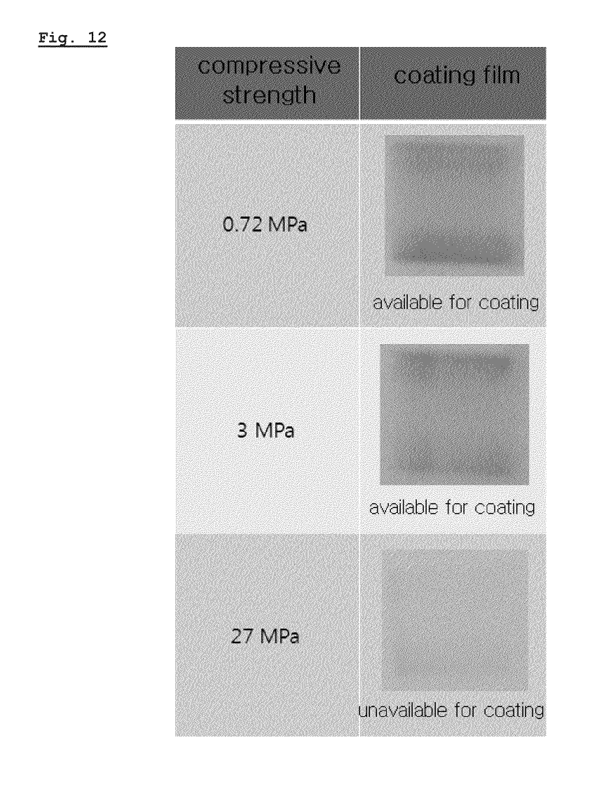

To measure the changes in compressive strength of yttria-stabilized zirconia (YSZ) granules according to heat treatment temperature, compressive strength of the yttria-stabilized zirconia (YSZ) granules was measured by using the method described in a paper (J. Kor. Ceram. Soc. Vol. 3, No. 6, 660-664 (1996)). And the results thereof are provided in Table 6 below and FIG. 11.

TABLE 6

| | Compressive Strength (MPa) |
|---|---|
| Ex. 20 | 0.15 |
| Ex. 21 | 0.18 |
| Ex. 22 | 0.20 |

Referring to Table 6 above, compressive strength of the yttria-stabilized zirconia (YSZ) granules was changed according to the heat treatment temperature presented in Examples 20 to 22, and the compressive strength was increased when the heat treatment temperature was higher. And referring to the graph and images shown in FIG. 11, a coating film was formed even when the compressive strength of the yttria-stabilized zirconia (YSZ) granules was changed according to the heat treatment temperature. Based on this, it was confirmed that the compressive strength value can be controlled by properly adjusting the heat treatment temperature of the brittle material granules according to the present invention.

(4) Analysis of Compressive Strength of GDC and GDC/Gd₂O₃ Granules

To measure the changes in compressive strength of GDC and GDC/Gd₂O₃ granules according to heat treatment temperature, compressive strength of the GDC and GDC/Gd₂O₃ granules was measured by using the method described in a paper (J. Kor. Ceram. Soc. Vol. 3, No. 6, 660-664 (1996)). And the results thereof are provided in Table 7 below.

TABLE 7

| | Compressive Strength (MPa) |
|---|---|
| Ex. 23 | 0.34 |
| Ex. 24 | 0.37 |
| Ex. 25 | 0.07 |
| Ex. 26 | 0.48 |
| Ex. 27 | 0.1 |
| Ex. 28 | 0.27 |

Referring to Table 7 above, compressive strength of the GDC granules and GDC/Gd₂O₃ granules was changed according to the ratio of the added Gd₂O₃ and the heat treatment temperature. Based on this, it was confirmed that the compressive strength value can be controlled by properly adjusting the heat treatment temperature of the brittle material granules according to the present invention.

(5) Analysis of Compressive Strength of Yttria (Y₂O₃) Granules

To measure the changes in compressive strength of yttria (Y₂O₃) granules according to heat treatment temperature, compressive strength of the yttria (Y₂O₃) granules was measured by using the method described in a paper (J. Kor. Ceram. Soc. Vol. 3, No. 6, 660-664 (1996)). And the results thereof are provided in Table 8 below.

TABLE 8

| | Compressive Strength (MPa) |
|---|---|
| Ex. 44 | 0.055 |
| Ex. 45 | 0.081 |
| Ex. 46 | 0.080 |
| Ex. 47 | 0.085 |
| Ex. 48 | 0.081 |

Referring to Table 8 above, compressive strength of the yttria granules was changed according to the increased heat treatment temperature, and the compressive strength was on the increase as the heat treatment temperature was increased as in Examples 44 to 48. Based on this, it was confirmed that the compressive strength value can be controlled by properly adjusting the heat treatment temperature of the brittle material granules according to the present invention.

### Experimental Example 5

### Analysis on Coating Possibility According to Compressive Strength of Granules of Brittle Material

To analyze the possibility for coating according to the change of granule strength, coating was performed through the room-temperature granule spray in vacuum while changing the compressive strength of the granules of aluminum oxide (Al₂O₃) brittle material. The results of the analysis are provided in FIG. 12.

Referring to FIG. 12, the brittle material (Al₂O₃) granules whose compressive strengths are 0.72 MPa and 3 MPa formed a coating film through the room-temperature vacuum injection. On the contrary, the brittle material granules whose compressive strength exceeds 27 MPa did not form a coating film. Based on this, it was confirmed that the granules of a brittle material according to the present invention, which had the compressive strength value of 0.05 to 20 MPa, can form a coating film via the room-temperature granule spray in vacuum.

### Experimental Example 6

### Analysis on Coating Possibility of the Granules and Powder of Molybdenum Disulfide (MoS₂) Through Room-Temperature Vacuum Injection

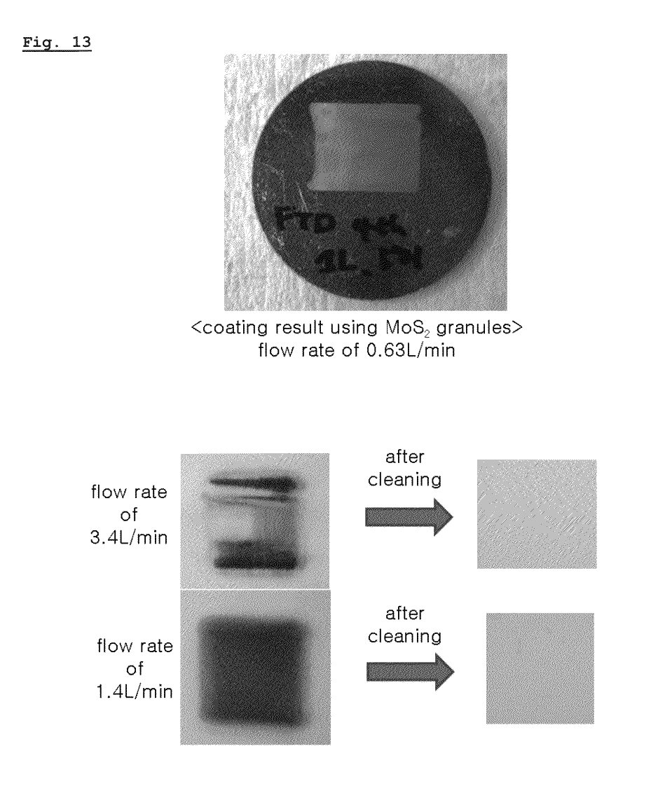

The molybdenum disulfide (MoS₂) granules prepared in Example 42 and the molybdenum disulfide powder (particle size: 0.6 μm, refer to Experimental Example 1) used as a raw material for the molybdenum disulfide granules were vacuum injected at room temperature and formed a coating film. The results thereof are provided in FIG. 13.

Referring to FIG. 13, a coating film was formed by vacuum injecting the molybdenum disulfide granules at room temperature. On the contrary, a coating film was not properly formed by vacuum injecting the molybdenum disulfide powder, and the coated part was easily cleaned. In addition, the molybdenum disulfide granules formed a desirable coating even at the flow rate of 0.69 L/min. On the contrary, the molybdenum disulfide powder formed a powder compact at the same flow rate as with the granules, and the coating was not desirably performed even though a relatively large flow rate was applied. Based on this, it was confirmed that granulating the powder (molybdenum disulfide) which was not able to form a coating film through the conventional vacuum injection at room temperature into the brittle material granules according to the present invention can form a coating film through the room-temperature granule spray in vacuum.

### Experimental Example 7

### X-Ray Diffraction Analysis

(1) Crystallographic Analysis of Brittle Material Granules

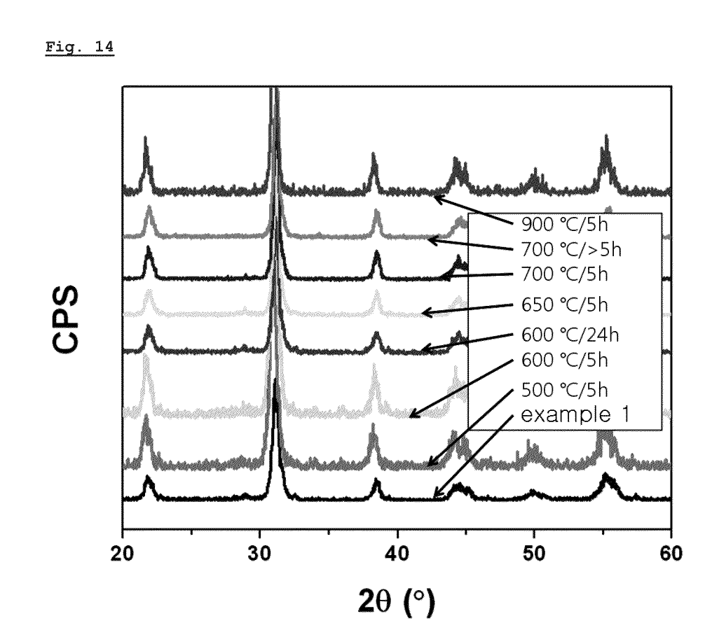

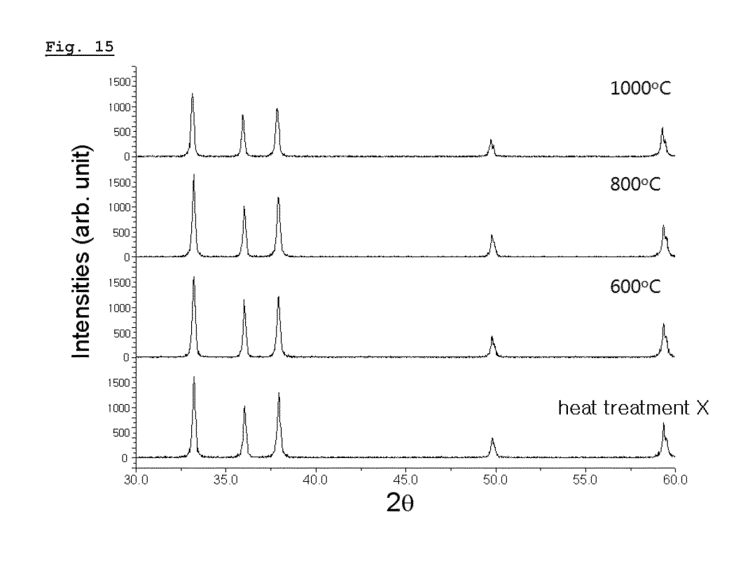

To investigate the changes in crystalline phase of the granules of brittle materials according to heat treatment temperature, X-ray diffraction analysis (XRD) was conducted after thermally heating the Pb(Zr,Ti)O₃ granules prepared in Example 1 and aluminum nitride (AlN) prepared in Example under nitrogen atmosphere. And the results of the analysis are provided in FIG. 14 and FIG. 15.

Referring to FIG. 14, the crystalline phase of the Pb(Zr,Ti)O₃ granules was not changed even when the granules were thermally treated at 500° C., 600° C., 650° C., 700° C., 800° C., and 900° C. for 5, 6, and 24 hours.

Further, referring to FIG. 15, the crystalline phase of the aluminum nitride (AlN) granules was not changed even when the granules were thermally treated at 600° C., 800° C., and 1000° C. Based on this, it was confirmed that the crystalline phase of the brittle material granules was not changed even after heat treatment.

(2) Crystallographic Analysis of Brittle Material Coating Films

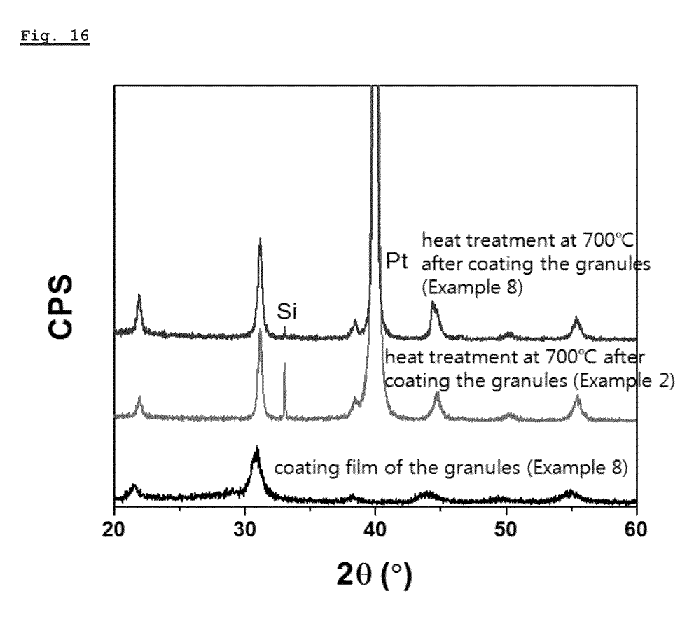

To investigate the changes in crystalline phase, X-ray diffraction analysis (XRD) was conducted after forming a coating film by room-temperature granule spray in vacuum of the Pb(Zr,Ti)O₃ granules prepared in Examples 2 and 8 and thermally heating the formed coating film. And the results of the analysis are provided in FIG. 16.

As shown in FIG. 16, after coating the Pb(Zr,Ti)O₃ granules of the present invention and post-heating the coating film, a second phase did not occur to the coating film and the crystalline phase of the coating film was not changed. Based on this, it was confirmed that the crystal structure of the coating film is not changed according to heat treatment condition for preparing the granules.

### Experimental Example 8

### Observation through Scanning Electron Microscope

(1) Analysis of Microstructure of Pb(Zr,Ti)O₃ Granules

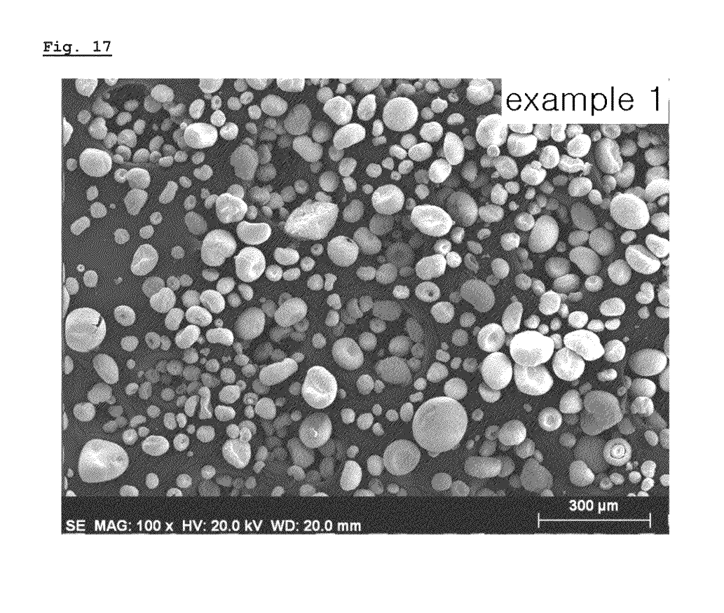

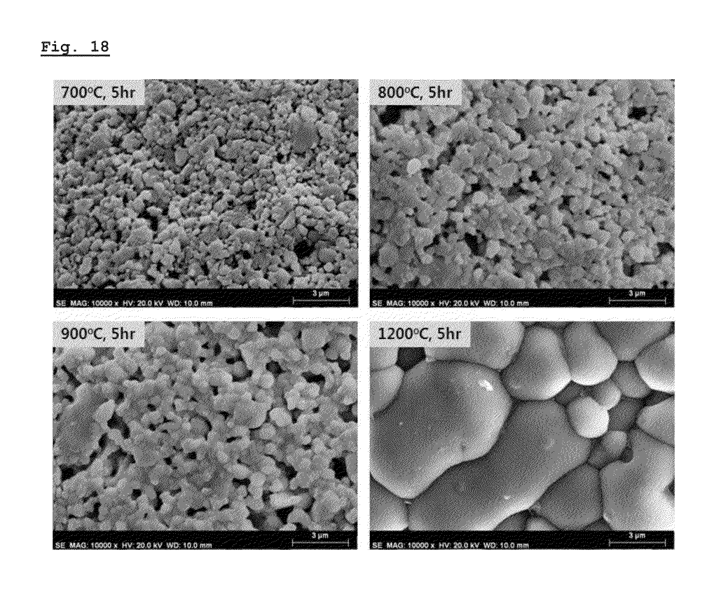

To observe the changes in microstructure of the Pb(Zr,Ti)O₃ granules prepared in Example 1 according to heat treatment temperature, observations were made through a scanning electron microscope. And the results of the observations are provided in FIG. 17 and FIG. 18.

Referring to FIG. 17, the Pb(Zr,Ti)O₃(PZT) granules according to the present invention were prepared as a spherical form. Referring to FIG. 18, a granular form combined with large particles was found as the heat treatment temperature was higher, as a result of thermally treating the granules at 700° C., 800° C., 900° C., and 1200° C.

(2) Analysis of Microstructure of Pb(Zr,Ti)O₃ Coating Film

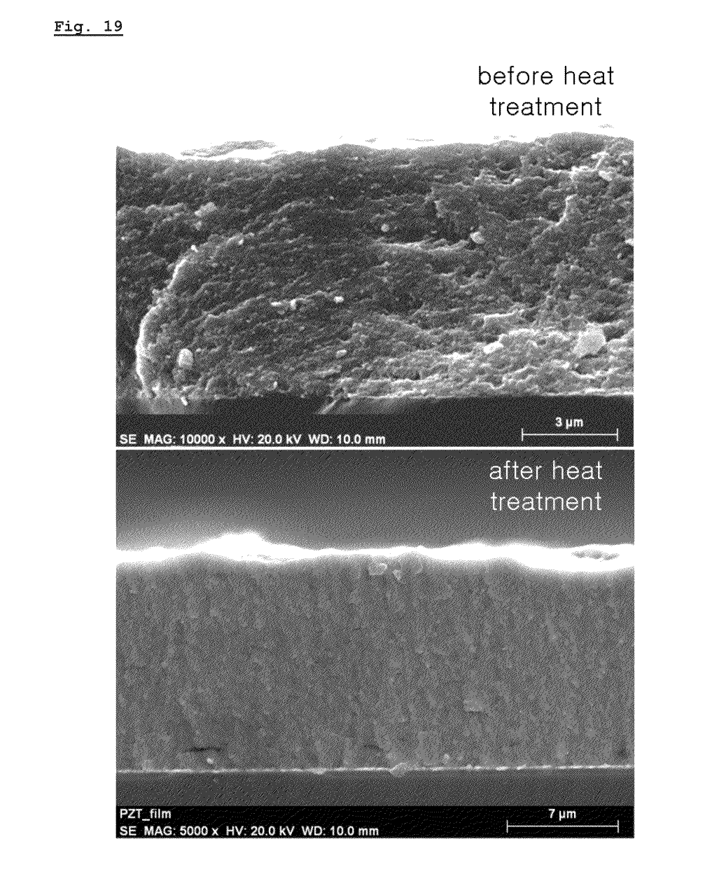

A coating film was prepared by room-temperature granule spray in vacuum of the Pb(Zr,Ti)O₃(PZT) granules prepared in Example 8. The formed coating film was thermally treated at 700° C. for 1 hour. And the change of the microstructure before and after the heat treatment was observed through a scanning electron microscope. And the results of the observations are provided in FIG. 19.

Referring to FIG. 19, the coating film formed by room-temperature granule spray in vacuum of the Pb(Zr,Ti)O₃(PZT) granules had a desirable and uniform microstructure without cracks and lamella structure. In addition, there were no cracks on the coating film even after the heat treatment. Based on this, it was confirmed that a coating film can be formed by room-temperature granule spray in vacuum of the granules of a brittle material according to the present invention at room temperature, and the formed coating film has a desirable microstructure.

(3) Analysis of Microstructure of GDC and GDC/Gd₂O₃ Coating Film

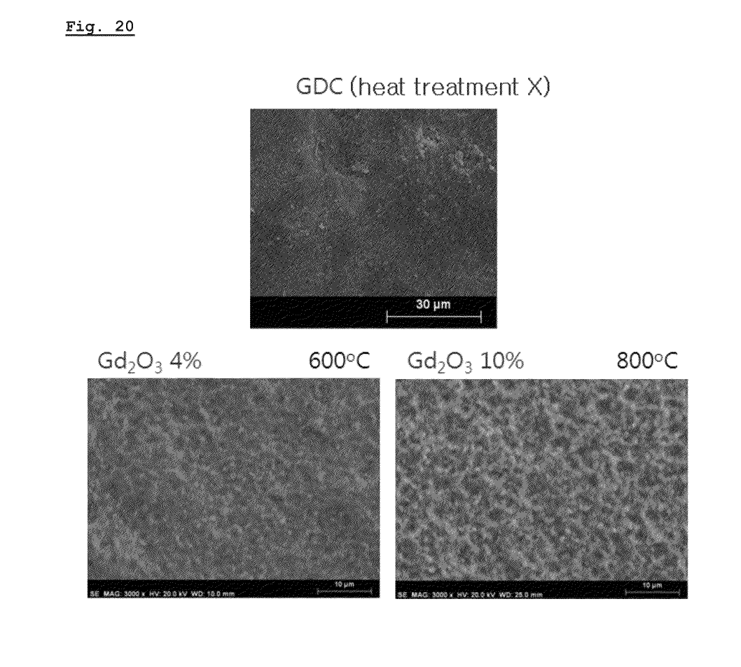

The coating film, which was formed by room-temperature granule spray in vacuum of the GDC granules prepared in Example 23 and GDC/Gd₂O₃ granules prepared in Examples 25 and 27, was observed through a scanning electron microscope. And the results of the observation are provided in FIG. 20.

Referring to FIG. 20, a coating film was formed by room-temperature granule spray in vacuum of the GDC granules prepared in Example 23, and also a coating film was formed by room-temperature granule spray in vacuum of the GDC/Gd₂O₃ granules prepared by mixing Gd₂O₃ and GDC prepared in Example 25 and Example 27, respectively. Based on this, it was confirmed that a coating film can be formed even by using the powder of the mixed brittle material granules according to the present invention.

(4) Analysis of Hydroxyapatite (HA) Granules and Microstructure of the Coating Film

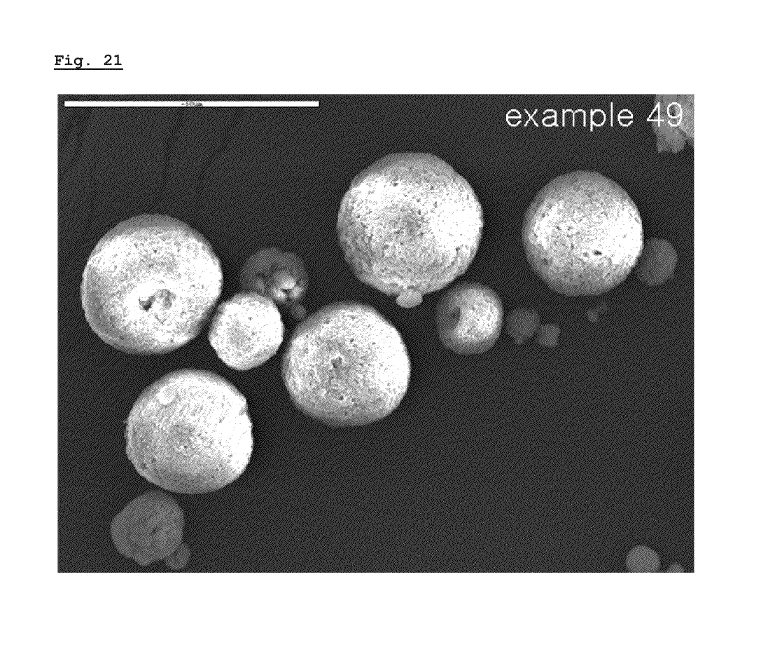

To analyze the microstructures of the hydroxyapatite (HA) granules prepared in Examples 49 and 52 and the microstructures of the hydroxyapatite coating films, observations were made through a scanning electron microscope. And the results of the observations are provided in FIGS. 21 to 23.

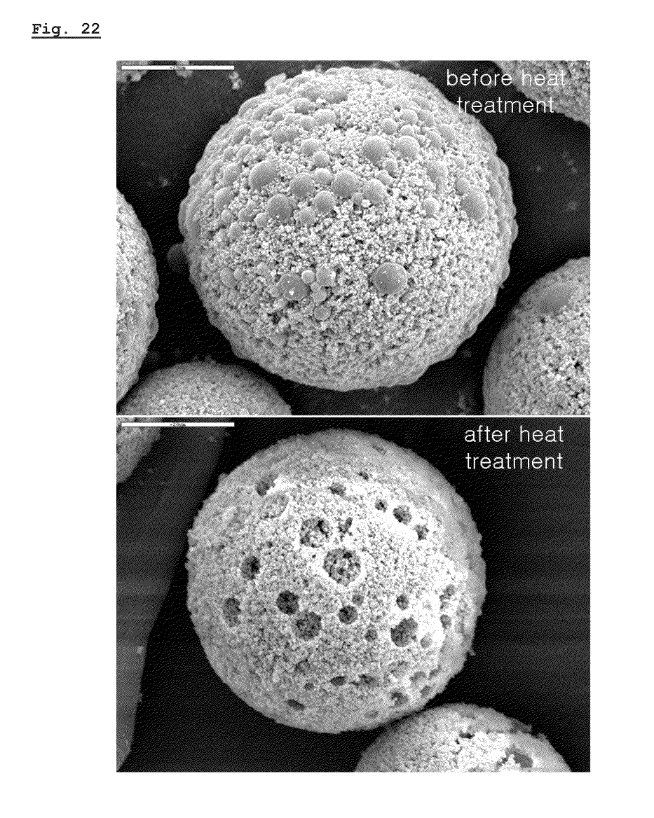

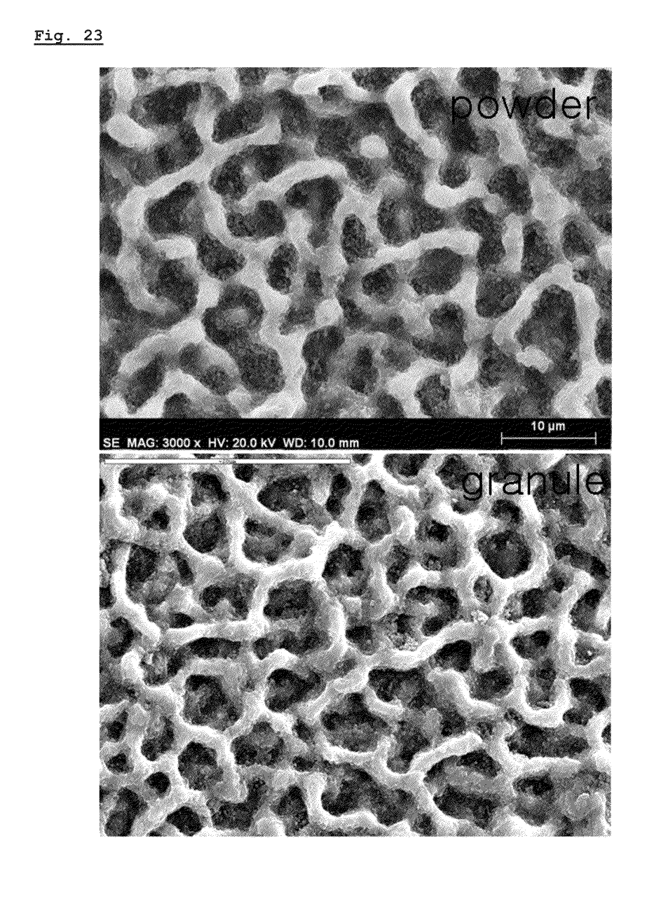

Referring to FIG. 21, the hydroxyapatite (HA) granules prepared in Example 49 were prepared as a spherical form. Further, as shown in FIG. 22, the hydroxyapatite (HA) granules prepared in Example 52 contained the PMMA particles before heat treatment, but the PMMA particles were removed through the heat treatment, and then pores were formed in the places where the PMMA particles had been positioned. Further, as shown in FIG. 23, there was no difference between the microstructure of the coating film formed by using the hydroxyapatite granules of Example 49 and the microstructure of the coating film formed by using the hydroxyapatite powder. Based on the result, it was confirmed that pores can be formed if the hydroxyapatite granules are prepared as a spherical form and polymer is added. Furthermore, it was confirmed that the brittle material granules according to the present invention can form a coating film whose structure is not different compared to the coating film formed by using the conventional powder.

### Experimental Example 9

### Analysis of Coating Properties According to Coating Condition for the Brittle Material Granules

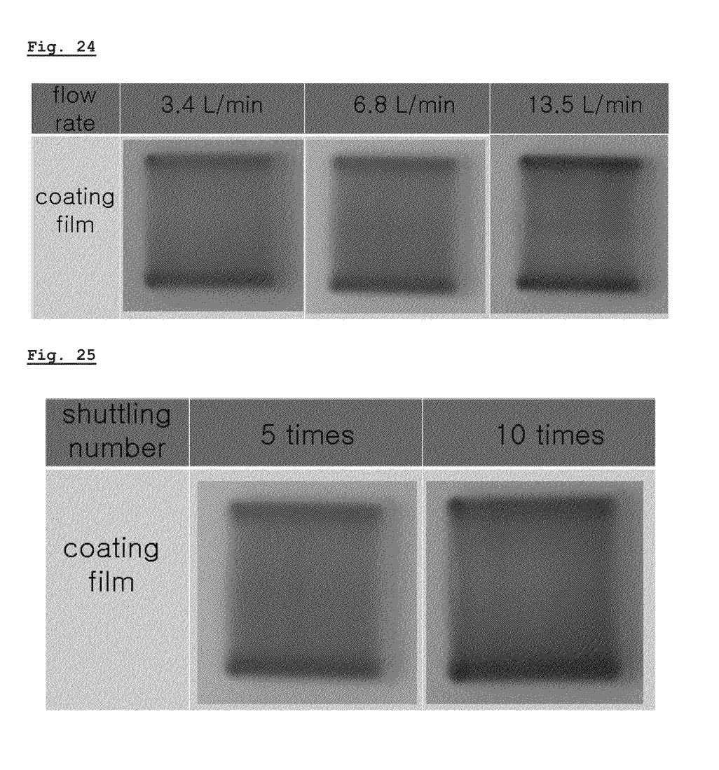

To analyze coating properties according to flow rate of the brittle material granules and substrate shuttling number, coating was performed through the room-temperature granule spray in vacuum while varying the flow rate of the yttria-stabilized zirconia (YSZ) granules prepared in Example 21 and the substrate shuttling number. And the results thereof are provided in FIG. 24 and FIG. 25.

Referring to FIG. 24, the yttria-stabilized zirconia (YSZ) granules were vacuum injected at room temperature while varying the flow rate of the carrier gas during the injection. And the surface of the coating film according to the gas flow rate change was observed. As a result of the observation, the amount of the granules formed into the coating film increased as the gas flow rate increased and accordingly appeared darker on the image. Further, as shown in FIG. 25, a larger amount of the granules was formed into the coating film as a result of increasing the substrate shuttling number from 5 to 10 and accordingly appeared darker on the image. Based on this, it was confirmed that a coating film can be formed by room-temperature granule spray in vacuum of the granules of a brittle material and the coating process can be desirably performed by controlling the coating condition properly.

### Experimental Example 10

### Analysis of Large-Area Coating Ability of Brittle Material Granules

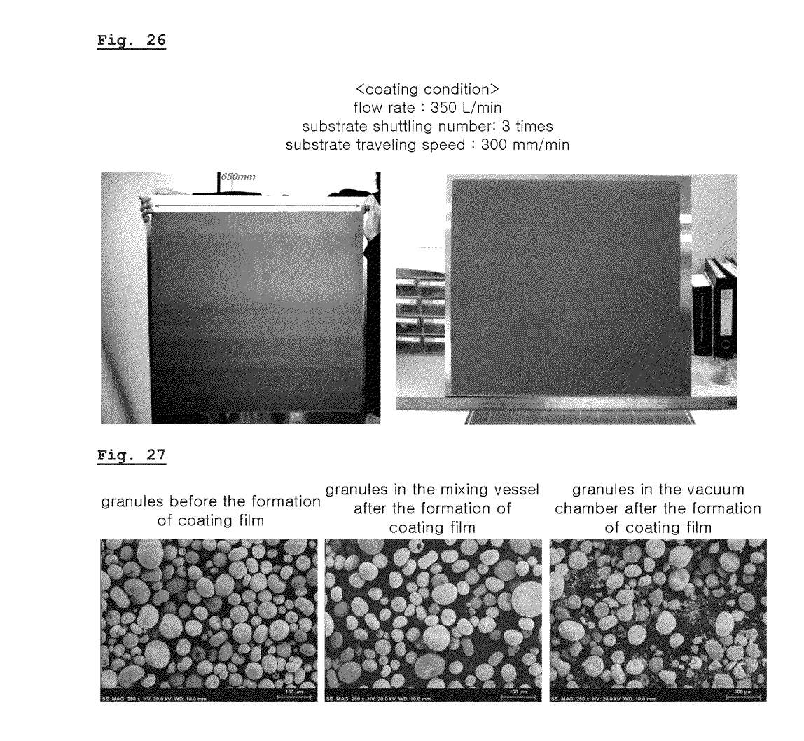

To investigate whether a large-area substrate can be coated by using the granules of brittle materials according to the present invention, the TiO₂ granules and TiO₂ raw powder prepared in Example 12 were injected to coat the substrate with area of 600×650 (mm²). The same coating condition was applied to the TiO₂ granules and the TiO₂ powder. And the results thereof are provided in FIG. 26.

Referring to FIG. 26, a non-uniform pattern of lateral lines was observed on the substrate when coating a large-area substrate by using the general TiO₂ powder. On the contrary, a uniform coating film was formed on the surface of a large-area substrate when using the TiO₂ granules. Based on this, it was confirmed that the granules of brittle materials according to the present invention can be continuously supplied through the room-temperature granule spray in vacuum and thus the granules are desirable for the coating of a large-area substrate.

### Experimental Example 11

### Analysis of Particle State Before/After Coating the Brittle Material Granules

To analyze the states of the brittle material granules before and after the room-temperature granule spray in vacuum, observations were made on the granules before fed into the room-temperature granule spray in vacuum apparatus (Example 1), the granules not transported to the nozzle but remained in the feeder, and the granules injected through the nozzle and remained in the vacuum chamber. The observations were made by using a scanning electron microscope. And the results of the observations are provided in FIG. 27.

Referring to FIG. 27, the granules not transported to the nozzle but remained, and the granules injected through the nozzle and remained in the vacuum chamber maintained a granular form, which is identical to the granular form of the granules before fed into the room-temperature granule spray in vacuum apparatus. Based on this, it was confirmed that the granules of brittle materials are injected through a nozzle with the form not disintegrated during the room-temperature granule spray in vacuum, and maintain the granular form even after injected through the nozzle.

### Experimental Example 12

### Analysis on Electrical Properties of Brittle Material Coating Films

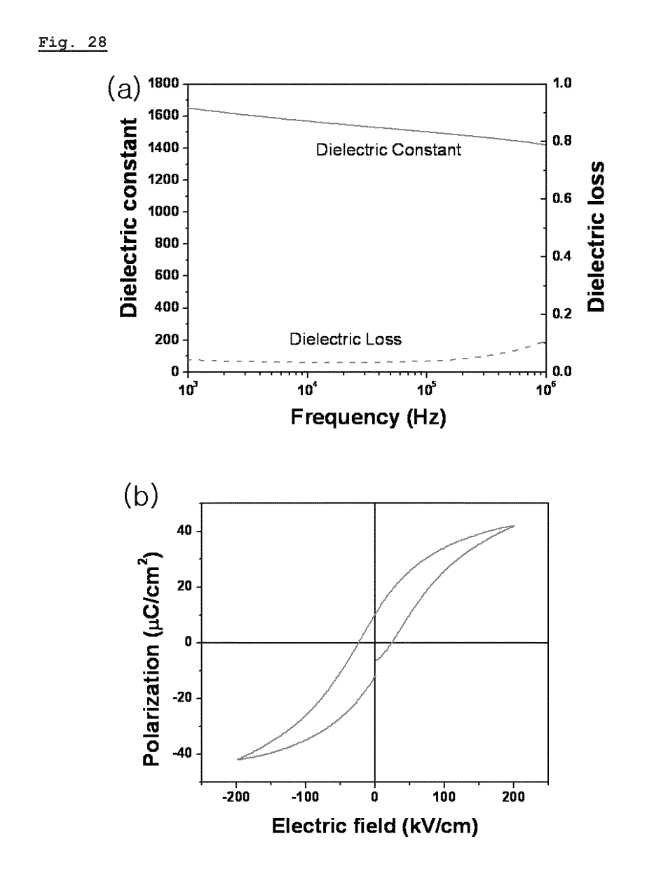

A Pb(Zr,Ti)O₃ coating film was prepared after forming the coating film by using the Pb(Zr,Ti)O₃ granules prepared in Example 7 according to the present invention and performing the post heat treatment at 700° C. The electrical properties of the prepared Pb(Zr,Ti)O₃ coating film was analyzed by means of dielectric constant and polarization vs electric field ferroelectricity measuring method. And the results of the analysis are provided in FIG. 28.

Referring to FIG. 28, the Pb(Zr,Ti)O₃ coating film presented a typical ferroelectric coating film property as a result of analyzing the dielectric properties ((a) of FIG. 23) and the ferroelectric hysteresis curve ((b) of FIG. 23) of the Pb(Zr,Ti)O₃ coating film prepared by using the Pb(Zr,Ti)O₃ granules according to the present invention.

1-20. (canceled)

21. A method for forming a coating film of a brittle material, the method comprising the following steps of:
a material preparing step at which granules of a brittle material, granulated from 0.1 to 6 μm powder particles, are charged into a feeder and a substrate is arranged in a vacuum chamber (step 1);
a gas supplying step at which a carrier gas is supplied and the granules of the brittle material and the carrier gas are mixed together (step 2); and
a granule injecting step at which the carrier gas and the granules of the brittle material mixed at step 2 are transported to a nozzle and injected onto the substrate of step 1 through the nozzle (step 3).

22. The method according to claim 21, wherein the granules of the brittle material of step 1 are in a range of 5 to 500 μm in size when injected onto the substrate of step 3.

23. The method according to claim 22, wherein an additional disintegrating process is omitted.

24. The method according to claim 21, wherein the granules of the brittle material at step 1 have a mean diameter of 5-500 μm and a compressive strength of 0.05-20 MPa.

25. The method according to claim 21, wherein the particles at step 1 are a mixture of one or more selected from the group consisting of hydroxyapatite, calcium phosphate, bio glass, Pb(Zr,Ti)O₃(PZT), alumina, titanium dioxide, zirconia (ZrO₂), yttria (Y₂O₃), yttria stabilized zirconia (YSZ), dysprosia (Dy₂O₃), gadolinia (Gd₂O₃), ceria (CeO₂), gadolinia doped ceria (GDC), magnesia (MgO), barium titanate (BaTiO₃), nickel manganite (NiMn₂O₄), potassium sodium niobate (KNaNbO₃), bismuth potassium titanate (BiKTiO₃), bismuth sodium titanate (BiNaTiO₃), CoFe₂O₄, NiFe2O4, BaFe₂O₄, NiZnFe₂O₄, ZnFe₂O₄, MnₓCo₃₋ₓO₄ (where, x is a positive real number of 3 or less), bismuth ferrite (BiFeO₃), bismuth zinc niobate (Bi_{1.5}Zn₁Nb_{1.5}O₇), lithium aluminum titanium phosphate glass ceramic, Li—La—Zr—O based garnet oxide, Li—La—Ti—O based perovskite oxide, La—Ni—O based oxide, lithium iron phosphate, lithium-cobalt oxide, Li—Mn—O based spinel oxide (lithium-manganese oxide), lithium aluminum germanium phosphate, tungsten oxide, tin oxide, lanthanum nickelate, lanthanum-strontium-manganese oxide, lanthanum-strontium-iron-cobalt oxide, silicate-based phosphor, SiAlON-based phosphor, aluminum nitride, silicon nitride, titanium nitride, AlON, silicon carbide, titanium carbide, tungsten carbide, magnesium boride, titanium boride, metal oxide/metal nitride composite, metal oxide/metal carbide composite, ceramic/polymer composite, ceramic/metal composite, nickel, copper, tungsten and silicon.

26. The method according to claim 21, wherein the granules of the brittle material at step 1 comprise macropores which are 0.1 to 10 μm in size.

27. The method according to claim 21, wherein step 1 of preparing the granules of the brittle material comprises the following steps of:
preparing a slurry by mixing the 0.1 to 6 μm powder of the particles and a solvent and adding a binder (step a); and
granulating the slurry prepared at step a (step b).

28. The method according to claim 27, wherein the binder at step a is one or more organic matter selected from the group consisting of polyvinyl alcohol (PVA), polyacrylic acid (PAA), 2-octanol, polyvinyl butyral (PVB), and polyethylene glycol (PEG).

29. The method according to claim 27, comprising performing a heat treatment to remove the organic matter present from the granules of the brittle material after the granulating at step b.

30. The method according to claim 29, wherein the heat treatment is performed at 200-1500° C. for 1-24 hours.

31. The method according to claim 21, wherein step 1 of preparing the granules of the brittle material comprises the following steps of:
preparing a slurry by mixing the 0.1 to 6 μm powder of the particles, polymer, and the solvent and adding a binder (step a);
granulating the slurry prepared at step a (step b); and
removing the polymer from the granules by thermally treating the granules granulated at step b (step c).

32. The method according to claim 31, wherein the polymer used at step a is one or more selected from the group consisting of polyvinylidene fluoride, polyimide, polyethylene, polystyrene, polymethyl methacrylate, polytetra fluoroethylene, and starch.

33. The method according to claim 21, wherein the granules of the brittle material at step 1 comprise a drug comprising an antibiotic or growth factor protein.

34. The method according to claim 21, wherein a flow rate of the carrier gas at step 3 is in a range of 0.1-6 L/min per 1 mm² of nozzle slit area.

35. The method according to claim 21, prior to injecting the granules of the brittle material, further comprising a step of injecting the carrier gas additionally.

36. A coating film of a brittle material prepared according to a method according to claim 21.

37. The coating film according to claim 36, wherein the coating film has a porosity of 10% or less.

38. The coating film according to claim 36, wherein the coating film has a uniform and fine structure free of a lamella structure and a pore.
